(19) United States
(12) Patent Application Publication
(10) Pub. No.: US 2026/0304543 A1
(43) Pub. Date: Oct. 1, 2026

(54) First Node, Second Node, Third Node and Methods Performed Thereby, for Handling a State of a Wireless Device

(71) Applicant: Telefonaktiebolaget LM Ericsson (publ), Stockholm (SE)

(72) Inventors: Mohammed Yazid Lyazidi, London (GB); Henrik Enbuske, Stockholm (SE); Jan Christoffersson, Luleå (SE); Liwei Qiu, Täby (SE); Revathy Narayanan, Sollentuna (SE)

(21) Appl. No.: 19/477,889

(22) PCT Filed: Jun. 10, 2024
(86) PCT No.: PCT/SE2024/050561

§ 371 Date: Oct. 23, 2025

Related U.S. Application Data
(60) Provisional application No. 63/507,488, filed on Jun. 12, 2023.

(51) Int. Cl. H04W 76/27

(52) U.S. Cl. CPC H04W 76/27

(57) ABSTRACT

A first node (111) in a radio network node (110) obtains (601, 603), while a wireless device (130) is inactive, at least one indication from another node (112, 113) in the radio network node (110) indicating whether the wireless device (130) is to be changed from to another state to receive data. The first node (111) determines (604), while the wireless device (130) is inactive, whether the wireless device (130) is to be changed and initiates (605) providing a further indication. The first node (111) is a central node managing a control plane. The at least one indication comprises at least one of: a first indication indicating conditions of a radio channel between the second node (112) and the wireless device (130), and a second indication indicating whether a size of a downlink buffer for data received is to be delivered to the wireless device (130) exceeds one or more thresholds.

### TECHNICAL FIELD

The present disclosure relates generally to a first node and methods performed thereby for handling a state of a wireless device. The present disclosure also relates generally to a second node, and methods performed thereby for handling the state of the wireless device. The present disclosure further relates generally to a third node, and methods performed thereby for handling the state of the wireless device.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### 3GPP MT SDT

In 3GPP, NR Mobile Terminated Small Data Transmission (MT-SDT) is being introduced in Release-18.

The Work Item Description (WID) contains as an objective to specify the support for paging-triggered SDT (MT-SDT) [RAN2, RAN3]. This further contains the following objectives. One objective is to specify an MT-SDT triggering mechanism for UEs in RRC_INACTIVE, supporting Random Access (RA-SDT) and Configured Grant (CG)-SDT as the UL response. Another objective is to specify MT-SDT procedure for initial DL data reception and subsequent UL/DL data transmissions in Radio Resource Control (RRC)_INACTIVE. Data transmission in DL within paging message is not in scope of this Work Item (WI).

The procedure for MT-SDT transmission may be as captured below from the agreed document in RAN3 #120 meeting R3-233413. Section 18.X of the document particularly concerns MT-SDT with/without UE context relocation. The overall procedure for MT-SDT procedure with or without UE context relocation may be as illustrated in FIG. 1, which is a reproduction of FIG. 18.X-1 of the document. At 0, a UE 11 may be in RRC_INACTIVE Connection Management (CM)-CONNECTED state. At 1, the DL user data from one or more corresponding User Plane Functions (UPFs) 12, and/or DL Non-Access Stratum (NAS) signalling from the Access and Mobility Management Function (AMF) 13, may be received at the Last Serving gNB 14 for the UE 11 in RRC_INACTIVE state. The last Serving gNB 14 may buffer the received DL user data and/or the NAS signalling. At 2, the Last Serving gNB 14 may send MT-SDT information to the neighbour gNBs within the RAN Notification Area (RNA), via XnAP RAN PAGING message. The MT-SDT information may be understood to be user identifier (ID) and an indication of DL MT-SDT data to the indicated UE. At 3, the gNB that receives the MT-SDT information within the RNA, may take into account the MT-SDT information received in the XnAP RAN PAGING message to decide whether to trigger MT-SDT Paging. The gNB which may ultimately reach the UE 11 via the Uu Paging may become the Receiving gNB 15. In case the MT-SDT information is received in step 2, the receiving gNB 15 may include an MT-SDT indicator in the Uu Paging message. The MT-SDT indicator may be understood to be at least a bit field that may notify the UE to trigger MT-SDT procedure. At 4/5, the UE 11 may decide to initiate MT-SDT procedure and send an RRCResumeRequest message for MT-SDT to the Receiving gNB 15. It may be noted that the above steps 3/4/5 may be revisited by RAN2 progress. At 6, the Receiving gNB 15 may identify the Last Serving gNB 14 using the Inactive Radio Network Temporary Identifier (I-RNTI) and retrieve the UE 11 context by means of XnAP Retrieve UE Context procedure. At 7, the following steps may be the same as FIGS. 18.2-1/18.3-1 from the cited document from step 3, except that the first Small Data Transmission (SDT) user data and/or NAS signalling may be DL SDT data and/or DL SDT NAS signalling. In case DL non-SDT data or DL non-SDT signalling may have arrived between step 2 and step 7, the Last Serving gNB 14 may need to relocate the UE 11 context to the Receiving gNB 15 and forward the received data to the Receiving gNB 15.

### NG-RAN Architecture

TS 38.401, v. 17.4.0 describes the overall NG-RAN architecture. FIG. 2, which is a reproduction of FIG. 1-1 of TS 38.401, v. 17.4.0, is a schematic diagram depicting an example of such an architecture. As depicted in FIG. 2, the NG-RAN 21 may comprise a set of gNBs 22 connected to the 5GC 23 through the NG interface 24. A gNB 22 may comprise a gNB-Central Unit (CU) 25 and one or more gNB-Distributed Unit(s) (DU(s)) 26. A gNB-CU 25 and a gNB-DU 26 may be connected via F1 interface 27. As shown in FIG. 2, this interface 27 may be responsible for possible information and control signalling from the Packet Data Convergence Protocol (PDCP) entity located in CU and Radio Link Control (RLC) entity located in DU. The set of gNBs 22 may be connected to each other via an Xn-C interface 25.

The overall architecture for separation of gNB-Central Unit Control Plane (CU-CP) and gNB-Central Unit User Plane (CU-UP) is depicted in FIG. 3, which is a reproduction of FIG. 1-2 of TS 38.401, v. 17.4.0. A gNB 31 may comprise a gNB-CU-CP 32, multiple gNB-CU-UPs 33 and multiple gNB-Dus 34. The gNB-CU-UP 33 may be connected to the gNB-CU-CP 32 through the E1 interface 35. One gNB-CU-UP 33 may be connected to only one gNB-CU-CP 32. The connectivity between a gNB-CU-UP 33 and a gNB-DU 34 may be established by the gNB-CU-CP 32 using Bearer Context Management functions. The gNB-CU-UP 33 may be connected to a gNB-DU 34 through an F1-U interface 35. The gNB-CU-CP 32 may be connected to a gNB-DU 34 through an F1-C interface 36.

The support of MT-SDT in split gNB architecture may be as captured in R3-233485 as follows, which is reproduced from section 8.18.x of R3-233485. The procedure for mobile terminated small data transmission in RRC Inactive may be as shown in FIG. 4, which is a reproduction of FIG. 8.18.x-1 of R3-233485. At 1, during the setup or modification of the bearer context as specified in Section 8.9.2 of R3-233485, the gNB-CU-CP 41 may request the gNB-CU-UP 42 to provide MT-SDT information. At 2a-0, the gNB-CU-UP 42 may receive DL data for the UE 43 in RRC Inactive on NG-U interface. At 2a-1, the gNB-CU-UP 42 may send a DL DATA NOTIFICATION message to the gNB-CU-CP 41. If determining that DL data packets are only mapped to SDT bearers, as requested in step 1, the gNB-CU-UP 42 may include the MT-SDT information in the DL DATA NOTIFICATION message. At 2b, the gNB-CU-CP 41 may receive DL NAS signalling over NG Application Protocol (NGAP). At 3, after 2a or 2b, the gNB-CU-CP 41 may send a PAGING message to the gNB-DU 44. The MT-SDT information may be included in the PAGING message. At 4, the gNB-DU 44 may send the Paging message to the UE 43. In case the MT-SDT information is received in step 3, the gNB-DU 44 may include the MT-SDT indicator in the Paging message. At 5, if the UE 43 has been successfully reached, it may initiate the RRC connection resume procedure as described in Section 8.6.2 or Section 8.9.6.2 of R3-233485, or initiate the SDT procedure as described in Section 8.18.1 of R3-233485 or from step 9 in Section 8.18.2 of R3-233485 or from step 1 in Section 8.18.3 of R3-233485 with the following difference: in case the SDT procedure is initiated, the UE 43 may indicate the RRC Resume Request is for MT-SDT, which may be without UL data.

During RAN3 #120 meeting discussion, the following issue was discussed in R3-232865. After triggering of MT-SDT from the network side, the gNB-CU-UP may need to keep detecting whether or not there may be any subsequent SDT data arrival during the ongoing MT-SDT session. The following special cases requiring fast termination of SDT may lead to some interactions with the corresponding gNB-CU-CP. One case, referred to in the document as Case 2, may concern non-SDT data arrival during an ongoing SDT session. In such a case, the existing DL DATA NOTIFICATION message may be sent without the new MT-SDT Information Information Element (IE). The new MT-SDT IE may be understood to refer to at least one bit that, if included, may trigger MT-SDT procedure. Another case, referred to in the document as Case 3, may concern when subsequent DL SDT data becomes large enough. In such a case, the question was raised of whether there may need to be a new indication in the MT-SDT Information IE in the DL DATA NOTIFICATION message.

Considering that Case 2 may be supported by reuse of existing mechanisms, it may only need to be considered whether to introduce a new indication in the MT-SDT Information IE in the DL DATA NOTIFICATION message to indicate to the gNB-CU-CP about the arrival of large size DL SDT Data, that is, case 3. This may be achieved by either defining a very big maximum value of the Data Size IE, or by introducing another optional IE to indicate big data in the MT-SDT Information IE in the DL DATA NOTIFICATION message, or by sending a DL DATA NOTIFICATION without an MT-SDT Information IE. In view of the foregoing, the document proposed that, to inform the gNB-CU-CP about the arrival of large size DL SDT Data, to further discuss whether to introduce an optional sub IE in the MT-SDT Information IE in the E1AP: DL DATA NOTIFICATION message.

### SUMMARY

As part of the development of embodiments herein, one or more challenges with the existing technology will first be identified and discussed.

In general, after a first signalling of the MT-SDT data size information over the E1AP DL DATA NOTIFICATION message, the gNB-CU-CP may trigger the SDT procedure, e.g., MT-SDT paging, where the UE may be kept in RRC_INACTIVE state to receive DL data.

In case of new subsequent DL data coming via a non-SDT bearer, this may correspond to the legacy case, where the DL Data Notification procedure may need to be sent without including the MT-SDT Data size information. This may be understood to correspond to case 2 as described above. The gNB-CU-CP may in this case perform a normal paging procedure and move the UE to RRC_CONNECTED state.

In case, however, of new subsequent DL data arriving via SDT bearers, the gNB-CU-UP may need to signal the MT-SDT data size information over the E1AP DL DATA NOTIFICATION message. Considering that there may be many subsequent DL data arriving from the Core Network and buffered at the gNB-CU-UP, if the subsequent DL data is big enough, continuing the MT-SDT procedure in RRC_INACTIVE may be inefficient compared to transmitting in RRC connected state, since the transmission of DL data over the radio interface (Uu) may be better optimized in Connected state.

According to the foregoing, it is an object of embodiments herein to improve the handling of a state of a wireless device in a communications network.

According to a first aspect of embodiments herein, the object is achieved by a method, performed by a first node. The first node is comprised in a radio network node. The method is for handling a state of a wireless device. The first node, the radio network node and the wireless device operate in a communications network. The first node, obtains while the wireless device is in inactive state, at least one indication from another node comprised in the radio network node. The at least one indication indicates whether the wireless device is to be changed from the inactive state to another state to receive downlink data from the radio network node. The first node determines, while the wireless device is in inactive state and based on the obtained at least one indication, whether the wireless device is to be changed from the inactive state to another state to receive downlink data from the radio network node. The first node then initiates providing a further indication of whether or not the wireless device is to be changed from the inactive state to another state, based on a result of the determining. The first node is a central node managing a control plane of the radio network node. The at least one indication comprises at least one of: a first indication and a second indication. In the embodiments wherein the at least one indication may comprise the first indication, the another node may be a second node managing a distributed unit (DU) of the radio network node. In such embodiments, the first indication may indicate one or more conditions of a radio channel between the second node and the wireless device. In the embodiments wherein the at least one indication may comprise the second indication, the another node may be a third node. The third node may be a central node managing a user plane of the radio network node. The second indication may indicate whether or not a size of a downlink buffer for data received at the third node to be delivered to the wireless device exceeds or not one or more thresholds.

According to a second aspect of embodiments herein, the object is achieved by a method, performed by the second node. The second node is comprised in the radio network node. The method is for handling the state of the wireless device. The second node, the radio network node and the wireless device operate in the communications network. The second node sends, while the wireless device is in inactive state, a first indication to the first node comprised in the radio network node. The first indication indicates whether the wireless device is to be changed from the inactive state to another state to receive downlink data from the radio network node. The second node receives, from the first node, while the wireless device is in inactive state and based on the sent first indication, the further indication. The further indication is of whether or not the wireless device is to be changed from the inactive state to the another state. The first node is the central node managing the control plane of the radio network node. The second node manages a distributed unit of the radio network node. The first indication indicates the one or more conditions of the radio channel between the second node and the wireless device.

According to a third aspect of embodiments herein, the object is achieved by a method, performed by the third node. The third node is comprised in the radio network node. The method is for handling the state of the wireless device. The third node, the radio network node and the wireless device are operating in the communications network. The third node sends, while the wireless device is in inactive state, a second indication to the first node comprised in the radio network node. The second indication indicates whether the wireless device is to be changed from the inactive state to the another state to receive downlink data from the radio network node. The third node receives, from the first node, while the wireless device is in inactive state and based on the sent second indication, the further indication. The further indication is of whether or not the wireless device is to be changed from the inactive state to the another state. The first node is the central node managing the control plane of the radio network node. The third node is the central node managing the user plane of the radio network node. The second indication indicates whether or not the size of the downlink buffer for data received at the third node to be delivered to the wireless device exceeds or not the one or more thresholds.

According to a fourth aspect of embodiments herein, the object is achieved by the first node. The first node is configured to be comprised in the radio network node. The first node is configured for handling the state of the wireless device. The first node, the radio network node and the wireless device are configured to operate in the communications network. The first node is configured to, obtain, while the wireless device is in inactive state, the at least one indication from the another node configured to be comprised in the radio network node. The at least one indication is configured to indicate whether the wireless device is to be changed from the inactive state to the another state to receive downlink data from the radio network node. The first node is to determine, while the wireless device is in inactive state and based on the at least one indication configured to be obtained, whether the wireless device is to be changed from the inactive state to the another state to receive downlink data from the radio network node. The first node is also configured to initiate providing the further indication of whether or not the wireless device is to be changed from the inactive state to the another state, based on the result of the determining. The first node is configured to be the central node configured to manage the control plane of the radio network node, and the at least one indication is configured to be at least one of: a) the first indication, wherein the another node may be configured to be the second node configured to manage the distributed unit of the radio network node, and the first indication may be configured to indicate the one or more conditions of the radio channel between the second node and the wireless device, and b) the second indication, wherein the another node may be configured to be the third node, the third node may be configured to be the central node configured to manage the user plane of the radio network node, and the second indication may be configured to indicate whether or not the size of the downlink buffer for data configured to be received at the third node to be delivered to the wireless device exceeds or not the one or more thresholds

According to a fifth aspect of embodiments herein, the object is achieved by the second node. The second node is configured to be comprised in the radio network node. The second node is configured to be for handling the state of the wireless device. The second node, the radio network node and the wireless device are configured to operate in the communications network. The second node is configured to send, while the wireless device is in inactive state, the first indication to the first node configured to be comprised in the radio network node. The first indication is configured to indicate whether the wireless device is to be changed from the inactive state to the another state to receive downlink data from the radio network node. The second node is also configured to receive, from the first node, while the wireless device is in inactive state and based on the first indication configured to be sent, the further indication of whether or not the wireless device is to be changed from the inactive state to the another state. The first node is configured to be the central node configured to manage the control plane of the radio network node, and the second node is configured to manage the distributed unit of the radio network node. The first indication is configured to indicate the one or more conditions of the radio channel between the second node and the wireless device.

According to a sixth aspect of embodiments herein, the object is achieved by the third node. The third node is configured to be comprised in the radio network node. The third node may be understood to be for handling the state of the wireless device. The third node, the radio network node and the wireless device are configured to operate in the communications network. The third node is configured to send, while the wireless device is in inactive state, the second indication to the first node configured to be comprised in the radio network node. The second indication is configured to indicate whether the wireless device is to be changed from the inactive state to the another state to receive downlink data from the radio network node. The third node is further configured to receive, from the first node, while the wireless device is in inactive state and based on the second indication configured to be sent, the further indication of whether or not the wireless device is to be changed from the inactive state to another state. The first node is configured to be the central node configured to manage the control plane of the radio network node, and the third node is configured to be the central node configured to manage the user plane of the radio network node. The second indication is configured to indicate whether or not the size of the downlink buffer for data configured to be received at the third node to be delivered to the wireless device exceeds or not the one or more thresholds.

By the first node obtaining the at least one indication from the another node, the first node may be enabled to determine whether the wireless device is to be changed from the inactive state to another state to receive downlink data from the radio network node, and initiate providing the further indication of whether or not the wireless device is to be changed from the inactive state to another state, based on a result of the determining.

The another indication may be the first indication from the second node and/or the second indication from the third node.

By the second node sending the first indication indicating the one or more conditions of the radio channel between the second node and the wireless device, the first node may be enabled to determine whether the wireless device is to be changed from the inactive state to another state based on the radio conditions. For example, the first node may be enabled to know if it may keep the wireless device in inactive state for the next subsequent downlink data transaction based on feedback from second node on the radio channel conditions, e.g., if the radio channel conditions are good. This may be even if a large amount of data may be received. This may help to improve the overall energy consumption of the wireless device.

By the third node sending the second indication indicating whether or not the size of the downlink buffer for data received at the third node to be delivered to the wireless device exceeds or not one or more thresholds, the first node may be allowed to switch the wireless device to, for example, connected state if a large amount of DL data appears at the buffer of the third node, during subsequent data transmissions, after, for example, an SDT procedure may have been initiated in NG-RAN. This may help to know that the SDT transaction may have to be aborted. This may also help to improve the overall energy consumption of the wireless device.

### BRIEF DESCRIPTION OF THE DRAWINGS

Examples of embodiments herein are described in more detail with reference to the accompanying drawings, according to the following description.

FIG. 1 is a signalling diagram depicting an example of MT-SDT with/without UE context relocation, according to existing methods.

FIG. 2 is a schematic diagram depicting an example of an F1 interface between gNB-CU and gNB-DU, according to existing methods.

FIG. 3 is a schematic diagram depicting an example of an overall architecture for separation of gNB-CU-CP and gNB-CU-UP, according to existing methods.

FIG. 4 is a signalling diagram depicting an example of Mobile Terminated Small Data Transmission in Radio Resource Control (RRC) Inactive state, according to existing methods.

FIG. 5 is a schematic diagram depicting an example of a communications network, according to embodiments herein.

FIG. 6 is a flowchart depicting a method in a first node, according to embodiments herein.

FIG. 7 is a flowchart depicting a method in a second node, according to embodiments herein.

FIG. 8 is a flowchart depicting a method in a third node, according to embodiments herein.

FIG. 9 is a signalling diagram depicting a non-limiting example of cases of subsequent data transmission, according to embodiments herein.

FIG. 10 is a signalling diagram depicting an example of methods performed by the first node, the second node and the third node, according to embodiments herein.

FIG. 11 is a schematic block diagram illustrating an embodiments of a first node, according to embodiments herein.

FIG. 12 is a schematic block diagram illustrating an embodiments of a second node, according to embodiments herein.

FIG. 13 is a schematic block diagram illustrating an embodiment of a third node, according to embodiments herein.

FIG. 14 is a flowchart depicting a method in a first node, according to examples related to embodiments herein.

FIG. 15 is a flowchart depicting a method in a second node, according to examples related to embodiments herein.

FIG. 16 is a flowchart depicting a method in a third node, according to examples related to embodiments herein.

### DETAILED DESCRIPTION

Certain aspects of the present disclosure and their embodiments may provide solutions to the challenges described in the Background and Summary sections herein, or other challenges. Embodiments herein may be generally understood relate to methods for configuring downlink data threshold information for mobile terminated small data transmission. Particularly, embodiments herein may relate to an approach whereby, the gNB-CU-CP may configure the gNB-CU-UP during the E1 message, e.g., E1 bearer context setup and modification procedures, with a threshold value of the DL data buffer above which the gNB-CU-CP may request the gNB-CU-UP to be informed when such threshold may be reached during subsequent MT-SDT transmission. The gNB-DU may inform the gNB-CU-CP of channel conditions indicating the possibility to keep the UE in RRC_INACTIVE state for DL SDT transactions, during initial and/or subsequent SDT transactions. The information from the gNB-DU may be used by the gNB-CU-CP to configure the threshold sent to the CU-UP. The gNB-CU-CP may make a decision on the RRC state of the UE for the next DL data transmission based on the gNB-CU-UP indication and/or the gNB-DU indication.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

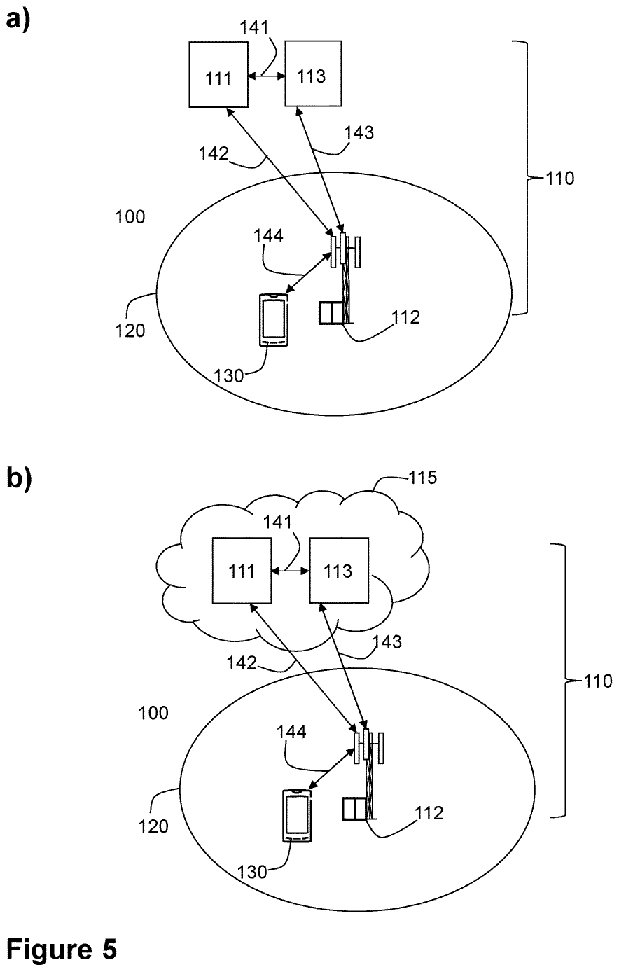

FIG. 5 depicts two non-limiting examples, in panel a) and panel b), respectively, of a communications network 100, sometimes also referred to as a wireless communications system, wireless communications network, cellular radio system, or cellular network, in which embodiments herein may be implemented. The communications network 100 may be a 5G system, 5G network, or Next Gen System. In other examples, the communications network 100 may be a newer system with similar functionality. Yet in other examples, the communications network 100 may, e.g., in addition, support other technologies such as, for example, Long-Term Evolution (LTE), e.g., LTE for Machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The communications network 100 may support Machine Type Communications (MTC), enhanced MTC (eMTC), Internet of Things (IoT) and/or Narrow Band IoT (NB-IoT). Thus, although terminology from 5G/NR and LTE may be used in this disclosure to exemplify embodiments herein, this should not be seen as limiting the scope of the embodiments herein to only the aforementioned system.

The communications network 100 may comprise a plurality of network nodes, whereof a radio network node 110 is depicted in the non-limiting example of FIG. 5. The radio network node 110 may be understood as a radio base station, for example a gNB, or any other network node with similar features capable of serving a user equipment, such as a wireless device or a machine type communication device, in the communications network 100.

The radio network node 110 may be directly connected to one or more core networks, e.g., to one or more network nodes in the one or more core networks.

The radio network node 110 comprises a first node 111, and another node 112, 113. The another node 112, 113 comprised in the radio network node 110 may be any or both of a second node 112 and a third node 113. Any of the first node 111, the another node 112, 113, the second node 112 and the third node 113 may be a network node.

The first node 111 may be understood as a Central Unit (CU) having a capability to manage a Control Plane (CP). The first node 111 may be capable to perform one or more functions as, for example, described in TS 38.401, v. 17.4.0, section 6.2.1. The first node 111 may be, e.g., a gNB CU-CP.

The second node 112 may be understood as a Distributed Unit (DU). The second node 112 may be controlled by the first node 111 and/or the second node 112. The second node 112 may have a direct connection with a wireless device 130 such as the wireless device 130. In some examples, the second node 112 may have a capability to manage lower layers of a protocol stack such as a Radio Link Control (RLC) layer, the Medium Access Control (MAC) layer and some parts of the Physical (PHY) Layer. The second node 112 may be capable to perform one or more functions as, for example, described TS 38.401, v. 17.4.0, section 6.2.1. The first node 111 may be, e.g., a gNB DU.

The third node 113 may be understood as a Central Unit (CU) having a capability to manage a User Plane (UP). The third node 113 may be capable to perform one or more functions as, for example, described TS 38.401, v. 17.4.0, section 6.2.1. The third node 113 may be, e.g., a gNB CU-UP.

In some examples, the first node 111, the second node 112 and the third node 113 may be co-located. In other examples, at least some of the first node 111, the second node 112 and the third node 113 may not be co-located. In particular examples, such as that depicted in FIG. 5 a, none of the first node 111, the second node 112 and the third node 113 may be co-located. In particular examples, such as that depicted in FIG. 5 b, the radio network node 110 may be a distributed node, and may partially perform some of its functions in the cloud 115, wherein in some examples, the first node 111 and the third node 113 may be located.

The communications network 100 may cover a geographical area, which in some embodiments may be divided into cell areas, wherein each cell area may be served by a radio network node, although, one radio network node may serve one or several cells. In the examples of FIG. 5, the radio network node 110 serves a cell 120. The radio network node 110 may be of different classes, such as, e.g., macro base station, home base station or pico base station, based on transmission power and thereby also cell size. In some examples, the radio network node 110 may serve receiving nodes with serving beams. The network node 100 may support one or several communication technologies, and its name may depend on the technology and terminology used.

A plurality of wireless devices may be located in the wireless communication network 100, whereof a wireless device 130, is depicted in the non-limiting example of FIG. 5. The wireless device 130 comprised in the communications network 100 may be a wireless communication device such as a User Equipment (UE), e.g., UE, 5G UE or nUE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such a headset, goggles, a printer or a file storage device, modem, or any other radio network unit capable of communicating over a radio link in a communications system. The wireless device 130 comprised in the communications network 100 may be enabled to communicate wirelessly in the communications network 100. The communication may be performed e.g., via a RAN, and possibly the one or more core networks, which may be comprised within the communications network 100.

The first node 111 may be configured to communicate with the third node 113 over a first link 141, e.g., a wired link. The second node 112 may be configured to communicate with the first node 111 over a second link 142, e.g., a wired link. The second node 112 may be configured to communicate with the third node 113 over a third link 143, e.g., a wired link. The wireless device 130 may be configured to communicate within the communications network 100 with the radio network node 110, e.g., the second node 112, over a fourth link 144, e.g., a radio link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third” and/or “fourth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a first node 111, e.g., a gNB CU-CP, a second node 112, e.g., a gNB CU-UP and a third node 113, e.g., a gNB-DU.

Some embodiments herein will now be further described with some non-limiting examples, which may be combined with the embodiments just described.

In the following description, any reference to a/the gNB-CU-CP may be understood to equally refer to the first node 111; any reference to a/the gNB-DU may be understood to equally refer to the second node 112; any reference to a/the gNB-CU-UP may be understood to equally refer to the third node 113; any reference to a/the gNB may be understood to equally refer to the radio network node 110; any reference to a/the UE, or simply “UE” may be understood to equally refer the wireless device 130; any reference to a/the “cell” may be understood to equally refer to the cell 120.

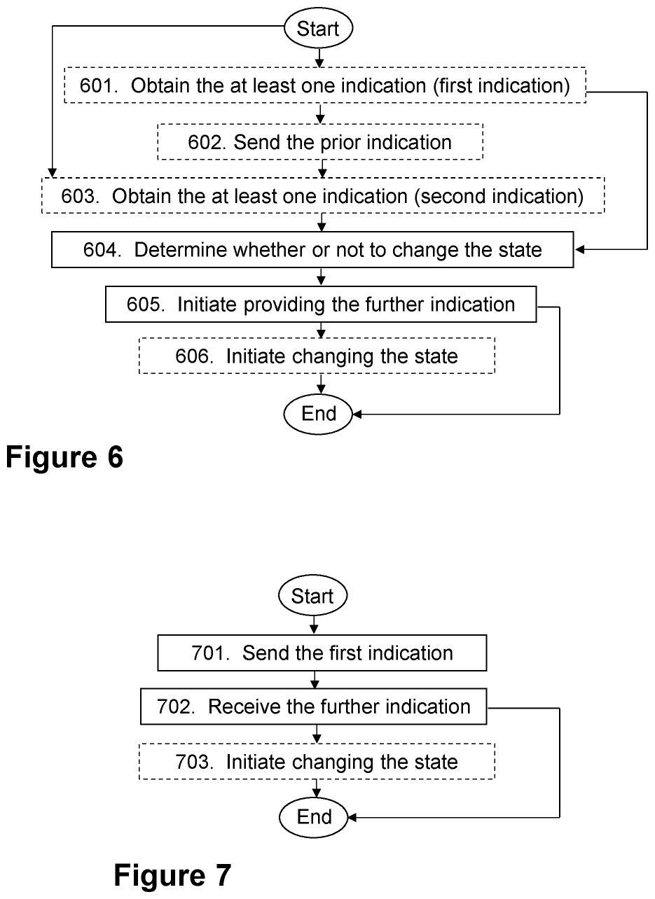

Embodiments of a method, performed by a first node, such as the first node 111, will now be described with reference to the flowchart depicted in FIG. 6. The first node 111 is comprised in the radio network node 110. The method is for handling a state of a wireless device, such as e.g., the wireless device 130. The first node 111, the radio network node 110 and the wireless device 130 operate in in a communications network, such as the communications network 100.

The method may be understood to be computer-implemented.

In some embodiments, the communications network 100 may be a 5G network. In some embodiments, the radio network node 110 may be a gNB.

In some embodiments, the first node 111 may be a CU-CP.

Several embodiments are comprised herein. The method may comprise the following actions. In particular examples, the method may comprise Action 601 and/or Action 603, Action 604 and Action 605. The method may comprise more of the following actions. In some embodiments, all the actions may be performed. One or more embodiments may be combined, where applicable. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 6. In FIG. 6 optional actions in some embodiments may be represented with dashed lines. In some embodiments, the actions may be performed in a different order than that depicted FIG. 6.

### Action 601

In this Action 601, the first node 111 obtains at least one indication.

The obtaining in this Action 601 is while the wireless device 130 is in inactive state.

The at least one indication is obtained from another node 112, 113 comprised in the radio network node 110.

Obtaining may comprise receiving, e.g., via the first link 141 from the third node 113 and/or via the second link 142 from the second node 112.

In some embodiments, the third node 113 may be a CU-UP. In some embodiments, the second node 112 may be a DU.

The at least one indication indicates whether the wireless device 130 is to be changed from the inactive state to another state to receive downlink data from the radio network node 110. The data may be small data. In some embodiments, the data may be a Small Data Transmission (SDT). In other words, the data may be configured for SDT, e.g., MT-SDT.

In some embodiments, the another state may be a state wherein the wireless device 130 may be connected to the radio network node 110, e.g., RRC Connected state.

The first node 111 is a central node managing a control plane of the radio network node 110. The at least one indication comprises at least one of: a first indication and a second indication.

### The First Indication

In the embodiments wherein the at least one indication may comprise the first indication, the another node 112 may be the second node 112 managing a distributed unit (DU) of the radio network node 110. In such embodiments, the first indication may indicate one or more conditions of a radio channel between the second node 112, or the radio network node 110, and the wireless device 130.

In some embodiments, the at least one indication may be the first indication.

In one example, after the first SDT transaction, the second node 112 may estimate the radio channel conditions based on the received Message 3 from the wireless device 130.

In some embodiments, the one or more conditions may be indicated by the first indication by at least one of the following options.

According to a first option, the one or more conditions may be indicated by the first indication by a first indicator of a quality of the radio channel, e.g., a Channel Quality Indicator (CQI).

According to a second option, the one or more conditions may be indicated by the first indication by a second indicator of a strength of a received reference signal, e.g., a Reference Signal Received Power (RSRP).

According to a third option, the one or more conditions may be indicated by the first indication by a third indicator of a number of subsequent downlink transmissions the second node 112 may be able to handle. In a particular example, the third indicator may indicate an estimation of the radio channel conditions in terms of how many subsequent DL SDT transactions may be sent to the wireless device 130.

According to a fourth option, the one or more conditions may be indicated by the first indication by a fourth indicator of a number of subsequent downlink transmissions the wireless device 130 may be able to handle.

According to a fifth option, the one or more conditions may be indicated by the first indication by a fifth indicator of a Uu metric.

According to a sixth option, the one or more conditions may be indicated by the first indication by a sixth indicator, e.g., a flag, explicitly indicating whether or not the wireless device 130 may have to be changed from the inactive state to the another state. In a particular example, the sixth indicator may be a flag indicating whether the wireless device 130 may need to continue to be kept in RRC_INACTIVE state.

In non-limiting particular examples, embodiments herein may describe the addition of the new parameters in E1AP signalling. In some of such examples, the second indication may be an indication gNB-DU→gNB-CU-CP.

After knowing the channel state conditions, e.g., after receiving a preamble/Msg3 e.g., from the wireless device 130, the second node 112, that is, the gNB-DU, may send an indication, that is, the first indication, to the first node 111, that is, the gNB-CU-CP, over an F1 message. Such indication may explicitly detail the CQI, RSRP, UE quality reporting, etc., or a flag indicating that UE conditions may be good enough to maintain the wireless device 130 in RRC_INACTIVE state for next subsequent DL small data transmission. In a further particular example, the second node 112 may send to the first node 111 over a F1 message new assistance information either as: a) the third indicator as an estimation of the radio channel conditions in terms of how many subsequent DL SDT transactions may be sent to the wireless device 130, or b) the sixth indicator as a flag indicating whether the wireless device 130 may need to continue to be kept in RRC_INACTIVE state. Alternatively, the second node 112 may send the first indication on the CQI, RSRP, UE reporting quality and Uu metrics values to the first node 111, so that the first node 111 may take them into account when configuring the prior indication, e.g., a Data volume threshold, as will be described in Action 602, and/or making a decision on a RRC state transition of the wireless device 130 during a subsequent SDT transaction, as will be described in Action 604.

Alternatively, the second node 112 may indicate, e.g., via the third indicator, the number of possible subsequent DL SDT transactions that the second node 112 may be able to handle.

In one example, the second node 112 may send the F1 message to the first node 111 after a first SDT transaction, after re-establishing all the SDT bearers. Alternatively, the second node 112 may also determine the radio channel conditions based on the CQI received or determined from the wireless device 130, using for e.g., preamble, before RRCResumeRequest and send this as the F1 message to the first node 111 before establishing the SDT bearers. This may offer the possibility for the network to switch the wireless device 130 directly to CONNECTED mode without initiating the SDT procedure under poor radio channel conditions.

### The Second Indication

In the embodiments wherein the at least one indication may comprise the second indication, the another node 112 may be the third node 113. The third node 113 may be a central node managing a user plane of the radio network node 110, that is, the third node 113 may be a CU-UP. The second indication may indicate whether or not a size of a downlink buffer for data received at the third node 113 to be delivered to the wireless device 130 exceeds or not one or more thresholds.

In some embodiments, the at least one indication may be the second indication.

In some embodiments, the at least one indication may comprise the first indication and the second indication.

In some embodiments, the second indication may be comprised in a Downlink Data Notification.

In one example, the third node 113 may itself be configured with a value of the buffer threshold or a list of threshold values of the buffered data volume. When the buffered data may reach the threshold, the third node 113 may inform the first node 111, so that the first node 111 may be aware that “RRC connected state” transition may be possible or requested.

In one example, the third node 113 may estimate a data volume to be scheduled by determining a size range of a packet flow by the data frame, c.f. Internet Protocol (IP) packet or other, based on an expected bit rate and a frame rate if applicable, used by an application or a service. For example, an estimated maximum data burst size of the packet flow of a service may be set as the maximum expected buffer/volume size and may be indicated to the first node 111. The indication from the third node 113 to the first node 111 may be of any means in descriptions in examples above. In one example, through signalling a value from a distribution used for generating code points of a table/tables, an indication of expecting a buffer/bit-rate value exceeding a predetermined threshold, alternatively an indication of an expected or existing burst size value in the transmitting third node 113, or an indication of a service bit/burst-rate. In one alternative, the indication may include a persistency indicator for conveying information on burst duration and/or periodicity, e.g., if a data burst is expected to be larger than one packet with a periodicity.

In non-limiting particular examples, embodiments herein may describe the addition of the new parameters in E1AP signalling. In some of such examples, the second indication may be an indication gNB-CU-UP→gNB-CU-CP.

For example, once MT-SDT may have debuted, if a large amount of subsequent DL data is detected by the third node 113 buffer, the third node 113 may send an indication to the first node 111.

The gNB-CU-UP may be informed that the ongoing SDT procedure is stopped and the UE has been changed to RRC_CONNECTED state.

In one example, the third node 113 may send regularly “notification messages” to the first node 111 as assistance information about the update volume of the data buffered at the third node 113, so that the first node 111 may take a decision on a paging scheme.

In a particular example, the second indication may be a DL Data Notification. In further particular examples, the second indication may have standard impact, as shown next. Additions according to embodiments herein are marked in bold, underlined font.

### 9.2.2.13 DL Data Notification

This message may be sent by the gNB-CU-UP to provide information about the DL data detection to the gNB-CU-CP.
Direction: gNB-CU-UP→gNB-CU-CP

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU-CP UE | M | | 9.3.1.4 | | YES | reject |
| E1AP ID | | | | | | |
| gNB-CU-UP UE | M | | 9.3.1.5 | | YES | reject |
| E1AP ID | | | | | | |
| Paging Priority | O | | 9.3.1.55 | | YES | ignore |
| Indicator (PPI) | | | | | | |
| PDU Session To | O | | | | YES | ignore |
| Notify List | | | | | | |
| >PDU Session To | | 1 . . . <maxnoof | | | — | — |
| Notify Item | | PDUSession | | | | |
| | | Resource> | | | | |
| >>PDU Session | M | | 9.3.1.21 | | — | — |
| ID | | | | | | |
| >>QoS Flow List | M | | 9.3.1.12 | | — | — |
| MT-SDT | O | | 9.3.1.xxx | | YES | ignore |
| Information | | | | | | |
| MT-SDT DV | O | | ENUMERATED(true, | | YES | ignore |
| Threshold crossed | | | . . . ) | | | |
| Stop SDT | | | | | | |

| Range bound | Explanation |
|---|---|
| maxnoofPDUSessionResource | Maximum no. of PDU Sessions |
| | for a UE. Value is 256. |

In some embodiments, the method may further comprise one or more of the following actions 602, 606.

### Action 602

In some embodiments, in this Action 602, the first node 111 may send a prior indication. The sending in this Action 602 may be to the third node 113.

The sending in this Action 203 may be, e.g., transmitting, and may be performed, e.g., via the first link 141.

The prior indication may indicate the one or more thresholds. Whenever the size of the downlink buffer for data received by the third node 113 for delivery to the wireless device 130 may be equal to or exceed at least one of the one or more thresholds, the third node 113 may have to notify the first node 111. The second indication may be obtained, that is, received, based on the sent prior indication.

In some embodiments, the one or more thresholds indicated in the prior indication may be based on the one or more conditions of the radio channel indicated by the second node 112 in the first indication.

In one example, the first node 111 may decide on the value(s) of the threshold based on the first indication received from the second node 112 on the radio channel conditions detailed in Action 601. In case of signalling a list of threshold values, the threshold values may be provided in an ordered list, e.g., from minimum value to maximum value. In one sub example, the threshold value may be set by the first node 111 as a combination of data volume+channel/link quality/RSRP that the first node 111 may have received from the second node 112. The list of threshold values may be per Data Radio Bearer (DRB), e.g., one threshold value for one DRB and a second for a second DRB.

In non-limiting particular examples, embodiments herein may describe the addition of the new parameters in E1AP signalling. In some of such examples, the second indication may be an indication gNB-CU-CP→gNB-CU-UP.

In some embodiments, the sending in this Action 602 of the prior indication may be performed during an E1 message.

In one example, the first node 111 may send a value of the buffer threshold or a list of threshold values over E1 message to the third node 113. In one option of this example, the PDCP discardTimer may be configured, or a new time value, in this document denoted Time_include, may be defined to determine which PDCP Service Data Units (SDUs) or PDCP Protocol Data Units (PDUs) may need to be counted when determining the buffer level in the third node 113.

In particular examples, in this Action 602, during an E1 message initiated by the first node 111, that is, the gNB-CU-CP, e.g. E1 BEARER CONTEXT SETUP message or E1 BEARER CONTEXT MODIFICATION messages, the first node 111 may indicate a value of the data buffer threshold to the third node 113, that is, the gNB-CU-UP.

In some embodiments, the prior indication may be comprised in one of: a BEARER CONTEXT SETUP REQUEST and a BEARER CONTEXT MODIFICATION REQUEST.

In particular examples of both of these embodiments, the prior indication may have standard impact, as shown next. Additions according to embodiments herein are marked in bold, underlined font.

### 9.2.2.1 Bearer Context Setup Request

This message may be sent by the gNB-CU-CP to request the gNB-CU-UP to setup a bearer context.
Direction: gNB-CU-CP→gNB-CU-UP

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU-CP UE | M | | 9.3.1.4 | | YES | reject |
| E1AP ID | | | | | | |
| Security | M | | 9.3.1.10 | | YES | reject |
| Information | | | | | | |
| UE DL | M | | Bit Rate | | YES | reject |
| Aggregate | | | 9.3.1.20 | | | |
| Maximum Bit | | | | | | |
| Rate | | | | | | |
| UE DL | O | | Bit Rate | The Bit Rate is a | YES | reject |
| Maximum | | | 9.3.1.20 | portion of the UE's | | |
| Integrity | | | | Maximum Integrity | | |
| Protected Data | | | | Protected Data | | |
| Rate | | | | Rate, and is | | |
| | | | | enforced by the | | |
| | | | | gNB-CU-UP node. | | |
| Serving PLMN | M | | PLMN | | YES | ignore |
| | | | Identity | | | |
| | | | 9.3.1.7 | | | |
| Activity | M | | 9.3.1.67 | | YES | reject |
| Notification | | | | | | |
| Level | | | | | | |
| UE Inactivity | O | | Inactivity | Included if the | — | — |
| Timer | | | Timer | Activity | | |
| | | | 9.3.1.54 | Notification Level | | |
| | | | | is set to UE. | | |
| Bearer Context | O | | ENUMERATED | Indicates the | YES | reject |
| Status Change | | | (Suspend, | status of the | | |
| | | | Resume, . . . , | Bearer Context. | | |
| | | | Resumefor | NOTE: This IE is | | |
| | | | SDT) | not applicable to | | |
| | | | | eNB-CP/eNB-UP | | |
| | | | | and ng-eNB-CU- | | |
| | | | | CP/ng-eNB-CU- | | |
| | | | | UP | | |
| CHOICE | M | | | | YES | reject |
| System | | | | | | |
| >E-UTRAN | | | | | | |
| >>DRB To | M | | DRB To | | YES | reject |
| Setup List | | | Setup List | | | |
| | | | E-UTRAN | | | |
| | | | 9.3.3.1 | | | |
| >>Subscriber | O | | 9.3.1.69 | | YES | ignore |
| Profile ID for | | | | | | |
| RAT/Frequency | | | | | | |
| priority | | | | | | |
| >>Additional | O | | 9.3.1.70 | | YES | Ignore |
| RRM Policy | | | | | | |
| Index | | | | | | |
| >NG-RAN | | | | | | |
| >>PDU | M | | 9.3.3.2 | | YES | reject |
| Session | | | | | | |
| Resource To | | | | | | |
| Setup List | | | | | | |
| RAN UE ID | O | | OCTET | | YES | ignore |
| | | | STRING | | | |
| | | | (SIZE(8)) | | | |
| gNB-DU ID | O | | 9.3.1.65 | Included | YES | ignore |
| | | | | whenever it is | | |
| | | | | known by the | | |
| | | | | gNB-CU-CP or by | | |
| | | | | the ng-eNB-CU- | | |
| | | | | CP | | |
| Trace Activation | O | | 9.3.1.68 | | YES | ignore |
| NPN Context | O | | 9.3.1.84 | | YES | reject |
| Information | | | | | | |
| Management | O | | MDT | | YES | ignore |
| Based MDT | | | PLMN List | | | |
| PLMN List | | | 9.3.1.89 | | | |
| CHO Initiation | O | | ENUMERATED | | YES | reject |
| | | | (True, | | | |
| | | | . . . ) | | | |
| Additional | O | | ENUMERATED(Discard | If set to “Discard | YES | ignore |
| Handover | | | PDCP | PDCP SN”, | | |
| Information | | | SN, . . . ) | indicates that the | | |
| | | | | forwarded PDCP | | |
| | | | | SNs have to be | | |
| | | | | removed | | |
| Direct | O | | 9.3.1.98 | | YES | ignore |
| Forwarding | | | | | | |
| Path Availability | | | | | | |
| gNB-CU-UP UE | O | | 9.3.1.5 | | YES | ignore |
| E1AP ID | | | | | | |
| MDT Polluted | O | | ENUMERATED | Indication on | YES | ignore |
| Measurement | | | (IDC, | whether MDT | | |
| Indicator | | | no-IDC, . . . ) | Measurement | | |
| | | | | affect (e.g., IDC) | | |
| | | | | is undertake or | | |
| | | | | not. | | |
| UE Slice | O | | 9.3.1.102 | | YES | ignore |
| Maximum Bit | | | | | | |
| Rate List | | | | | | |
| SCG Activation | O | | 9.3.1.105 | | YES | ignore |
| Status | | | | | | |
| MT-SDT | O | | ENUMERATED | Indicates to | YES | ignore |
| Information | | | (true, . . . ) | request the report | | |
| Request | | | | of MT-SDT | | |
| | | | | Information. | | |
| MT-SDT DV | | | INTEGER(0 | Indicates the MT- | YES | ignore |
| threshold | | | . . . 100000, . . .) | SDT data volume | | |
| value | | | | threshold | | |

| Range bound | Explanation |
|---|---|
| maxnoofDRBs | Maximum no. of DRBs for |
| | a UE. Value is 32. |
| maxnoofPDUSessionResource | Maximum no. of PDU Sessions |
| | for a UE. Value is 256. |

### Not Modified

### 9.2.2.4 Bearer Context Modification Request

This message may be sent by the gNB-CU-CP to request the gNB-CU-UP to modify a bearer context.
Direction: gNB-CU-CP→gNB-CU-UP

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.3.1.1 | | YES | reject |
| gNB-CU-CP UE | M | | 9.3.1.4 | | YES | reject |
| E1AP ID | | | | | | |
| gNB-CU-UP UE | M | | 9.3.1.5 | | YES | reject |
| E1AP ID | | | | | | |
| Security | O | | 9.3.1.10 | | YES | reject |
| Information | | | | | | |
| UE DL Aggregate | O | | Bit Rate | | YES | reject |
| Maximum Bit | | | 9.3.1.20 | | | |
| Rate | | | | | | |
| UE DL Maximum | O | | Bit Rate | The Bit Rate is a | YES | reject |
| Integrity | | | 9.3.1.20 | portion of the | | |
| Protected Data | | | | UE's Maximum | | |
| Rate | | | | Integrity | | |
| | | | | Protected Data | | |
| | | | | Rate, and is | | |
| | | | | enforced by the | | |
| | | | | gNB-CU-UP node. | | |
| Bearer Context | O | | ENUMERATED | Indicates the | YES | reject |
| Status Change | | | (Suspend, | status of the | | |
| | | | Resume, | Bearer Context | | |
| | | | . . . , | NOTE: This IE is | | |
| | | | Resumefor | not applicable to | | |
| | | | SDT, | eNB-CP/eNB-UP | | |
| | | | StopSDT) | and ng-eNB-CU- | | |
| | | | | CP/ng-eNB-CU- | | |
| | | | | UP. | | |
| New UL TNL | O | | ENUMERATED | Indicates that new | YES | reject |
| Information | | | (required, | UL TNL | | |
| Required | | | . . . ) | information has | | |
| | | | | been requested to | | |
| | | | | be provided. | | |
| UE Inactivity | O | | Inactivity | Included if the | — | — |
| Timer | | | Timer | Activity | | |
| | | | 9.3.1.54 | Notification Level | | |
| | | | | is set to UE. | | |
| Data Discard | O | | ENUMERATED | Indicate to discard | YES | ignore |
| Required | | | (required, | the DL user data | | |
| | | | . . . ) | in case of RAN | | |
| | | | | paging failure. | | |
| CHOICE System | O | | | | YES | reject |
| >E-UTRAN | | | | | | |
| >>DRB To | O | | DRB To | | YES | reject |
| Setup List | | | Setup | | | |
| | | | Modification | | | |
| | | | List E- | | | |
| | | | UTRAN | | | |
| | | | 9.3.3.7 | | | |
| >>DRB To | O | | DRB To | | YES | reject |
| Modify List | | | Modify List | | | |
| | | | E-UTRAN | | | |
| | | | 9.3.3.8 | | | |
| >>DRB To | O | | DRB To | | YES | reject |
| Remove List | | | Remove | | | |
| | | | List E- | | | |
| | | | UTRAN | | | |
| | | | 9.3.3.9 | | | |
| >>Subscriber | O | | 9.3.1.69 | | YES | ignore |
| Profile ID for | | | | | | |
| RAT/Frequency | | | | | | |
| priority | | | | | | |
| >>Additional | O | | 9.3.1.70 | | YES | ignore |
| RRM Policy | | | | | | |
| Index | | | | | | |
| >NG-RAN | | | | | | |
| >>PDU | O | | PDU | | YES | reject |
| Session | | | Session | | | |
| Resource To | | | Resource | | | |
| Setup List | | | To Setup | | | |
| | | | Modification | | | |
| | | | List | | | |
| | | | 9.3.3.10 | | | |
| >>PDU | O | | 9.3.3.11 | | YES | reject |
| Session | | | | | | |
| Resource To | | | | | | |
| Modify List | | | | | | |
| >>PDU | O | | 9.3.3.12 | | YES | reject |
| Session | | | | | | |
| Resource To | | | | | | |
| Remove List | | | | | | |
| RAN UE ID | O | | OCTET | | YES | ignore |
| | | | STRING | | | |
| | | | (SIZE(8)) | | | |
| gNB-DU ID | O | | 9.3.1.65 | | YES | ignore |
| Activity | O | | 9.3.1.67 | | YES | ignore |
| Notification Level | | | | | | |
| MDT Polluted | O | | ENUMERATED | Indication on | YES | ignore |
| Measurement | | | (IDC, no- | whether MDT | | |
| Indicator | | | IDC, . . . ) | Measurement | | |
| | | | | affect (e.g. IDC) is | | |
| | | | | undertake or not. | | |
| UE Slice | O | | 9.3.1.102 | | YES | ignore |
| Maximum Bit | | | | | | |
| Rate List | | | | | | |
| SCG Activation | O | | 9.3.1.105 | | YES | ignore |
| Status | | | | | | |
| SDT Continue | O | | ENUMERATED | Indicates ROHC | YES | reject |
| ROHC | | | (true, . . . ) | should be | | |
| | | | | continued for SDT | | |
| | | | | DRBs. This IE | | |
| | | | | corresponds to | | |
| | | | | information | | |
| | | | | provided in the | | |
| | | | | sdt-DRB- | | |
| | | | | ContinueROHC | | |
| | | | | contained in the | | |
| | | | | SDT-Config IE as | | |
| | | | | defined in TS | | |
| | | | | 38.331 [10]. | | |
| Management | O | | MDT | | YES | ignore |
| Based MDT | | | PLMN | | | |
| PLMN | | | Modification | | | |
| Modification List | | | List | | | |
| | | | 9.3.1.129 | | | |
| MT-SDT | O | | ENUMERATED | Indicates to | YES | ignore |
| Information | | | (true, . . . ) | request the report | | |
| Request | | | | of MT-SDT | | |
| | | | | Information. | | |
| MT-SDT DV | | | INTEGER | Indicates the | YES | ignore |
| threshold value | | | (0 . . . 10000, | MT-SDT data | | |
| | | | . . . ) | volume | | |
| | | | | threshold | | |

| Range bound | Explanation |
|---|---|
| maxnoofDRBs | Maximum no. of DRBs for a |
| | UE. Value is 32. |
| maxnoofPDUSessionResource | Maximum no. of PDU Sessions |
| | for a UE. Value is 256. |

### Action 603

In this Action 603, the first node 111 obtains at least one indication. That is, at least an additional indication. In particular examples of the method, such as that depicted in FIG. 6, the first node 111 may obtain the first indication in Action 601. In this Action 602, the first node 111 may obtain the second indication.

The at least one indication, that is, the at least one additional indication, is obtained from the another node 112, 113 comprised in the radio network node 110.

The obtaining in this Action 603 is while the wireless device 130 is in inactive state.

Obtaining may comprise receiving, e.g., via the first link 141 from the third node 113 and/or via the second link 142 from the second node 112.

As stated above, the second indication may indicate whether or not the size of the downlink buffer for data received at the third node 113 to be delivered to the wireless device 130 exceeds or not the one or more thresholds.

In one example, once the third node 113 may detect an amount of DL data for SDT that may be available at the buffer and that may cross, e.g., one of, the threshold value(s), the third node 113 may send an indication, that is, the second indication, to the first node 111 via E1 message. The amount of data for SDT which may be compared to the threshold may be according to one of these options: a) the total amount of data that may have been received during the entire SDT procedure, b) the total amount of data for which the PDCP discard timer may have not expired, and c) the total amount of data of the PDCP SDUs or PDCP PDUs that may have been received within the last Time_include time units.

This indication, that is, the second indication, may be corresponding to one of the threshold values, e.g., an enumerated value such as minimum threshold crossed, and so on. In some examples, the indication, that is, the second indication, may also indicate that the threshold has been exceeded. In some examples, the indication, that is, the second indication, may be a more detailed indication of the exact buffer level.

As stated earlier in one example, the third node 113 may send regularly “notification messages” to the first node 111 as assistance information about the update volume of the data buffered at the third node 113, so that the first node 111 may take a decision on a paging scheme. In one option, this regular reporting may be triggered by the buffer level exceeding a threshold value, e.g., one of the one or more thresholds indicated in the prior indication, and may be sent in a configurable interval. Such notification message may be a DL DATA NOTIFICATION message, or BEARER CONTEXT MODIFICATION RESPONSE message, and etc.

In one example, alternatively, the third node 113 may itself be configured, e.g., without receiving an E1 request, e.g., the prior indication, from the first node 111, with a value of the buffer threshold or a list of threshold values of the buffered data volume. When the buffered data may reach the threshold, the third node 113 may inform the first node 111, so that the first node 111 may be aware that “RRC connected state” transition may be possible or requested.

As stated earlier, the at least one indication indicates whether the wireless device 130 is to be changed from the inactive state to another state to receive downlink data from the radio network node 110. The data may be small data, e.g., an SDT. In other words, the data may be configured for SDT, e.g., MT-SDT.

### Action 604

In this Action 604, the first node 111 determines whether the wireless device 130 is to be changed from the inactive state to another state to receive downlink data from the radio network node 110.

Determining may be understood as calculating, selecting or deriving.

The determining in this Action 604 may be while the wireless device 130 is in inactive state and based on the obtained at least one indication. That is, based on the obtained first indication, the obtained second indication, or both.

In some examples, when receiving an indication from the third node 113, that is, the gNB-CU-UP, that the threshold value is crossed, the first node 111 may take a decision to switch the wireless device 130 to RRC_CONNECTED and to abort the ongoing SDT procedure.

In another example, after receiving the indication, that is, the second indication, on data volume threshold crossed from the third node 113 and/or indication from the second node 112 described in as the first indication, the first node 111 may make a decision on the state of the wireless device 130, that is, e.g., the UE RRC state. In case the first node 111 may decide to change the RRC state of the wireless device 130 to RRC_CONNECTED, the first node 111 may abort the SDT transaction and may, in the next Action 605, inform the third node 113 by sending an indicator, e.g., with a new enumerated value “stop” in the existing Bearer Status Change IE, or a new IE, to indicate that the ongoing SDT procedure may have to be stopped.

In some embodiments, the one or more thresholds may be to be used in combination with a value indicating a time period during which the data may be to be received in the downlink buffer.

### Action 605

In this Action 605, the first node 111 initiates providing a further indication.

Initiating providing may be understood as triggering, facilitating, starting or enabling sending, e.g., transmitting, e.g., via the first link 141 and/or the second link 143. The initiating providing in this Action 605 may be to at least one of the second node 112 and the third node 113.

In some embodiments, the first node 111 may, in this Action 605, send the further indication to at least one of the third node 113, the second node 112 and the wireless device 130.

The further indication is of whether or not the wireless device 130 is to be changed from the inactive state to another state. In particular examples, the further indication may be of whether or not the wireless device 130 may have to be changed from the inactive state to another state, to receive the downlink data from the radio network node 110.

The initiating providing in this Action 605 is based on a result of the determining in Action 604.

In some embodiments, the further indication may indicate that a Small Data Transmission procedure is to be stopped.

In some embodiments, the further indication may be comprised in a BEARER CONTEXT MODIFICATION REQUEST.

In some examples, during an E1 message initiated by the first node 111, that is, the gNB-CU-CP, e.g., E1 BEARER CONTEXT MODIFICATION message, the first node 111 may indicate to the third node 113, that is, the gNB-CU-UP, that an ongoing SDT procedure may need to be stopped.

### Action 606

In this Action 606, the first node 111 may initiate changing the state of the wireless device 130 from the inactive state to the another state. The initiating changing in this Action 606 may be based on a result of the determining in Action 603.

Embodiments of a method performed by a second node, such as the second node 112, will now be described with reference to the flowchart depicted in FIG. 7. The second node 112 is comprised in the radio network node 110. The method is for handling the state of the wireless device 130. The second node 112, the radio network node 110 and the wireless device 130 operate in a communications network, such as the communications network 100.

The method may be understood to be computer-implemented.

The method may comprise the following actions. In a particular example, Action 701 and Action 702 are performed. The method may comprise more of the following actions. In some embodiments, all the actions may be performed. Several embodiments are comprised herein. One or more embodiments may be combined, where applicable. It should be noted that the examples herein are not mutually exclusive. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 112 is depicted in FIG. 7. In FIG. 7, optional actions in some embodiments may be represented with dashed lines. In some embodiments, the actions may be performed in a different order than that depicted FIG. 7.

The detailed description of some of the following corresponds to the same references provided above, in relation to the actions described for the first node 111 and will thus not be repeated here to simplify the description. For example, the connected mode may be an RRC connected mode.

### Action 701

In this Action 701, the second node 112 sends the first indication.

The sending in this Action 701 is to the first node 111 comprised in the radio network node 110.

The sending in this Action 701 may be performed, e.g., via the second link 142.

The sending in this Action 701 is while the wireless device 130 is in inactive state.

The first indication indicates whether the wireless device 130 is to be changed from the inactive state to another state to receive downlink data from the radio network node 110. The data may be small data, e.g., an SDT. In other words, the data may be configured for SDT, e.g., MT-SDT.

The first node 111 is the central node managing the control plane of the radio network node 110. The second node 112 manages a distributed unit of the radio network node 110. The first indication indicates the one or more conditions of the radio channel between the second node 112, or the radio network node 110, and the wireless device 130.

In some embodiments, the one or more conditions may be indicated by the first indication by at least one of: a) the first indicator of a quality of the radio channel, e.g., the Channel Quality Indicator (CQI), b) the second indicator of the strength of the received reference signal, e.g., the Reference Signal Received Power (RSRP), c) the third indicator of the number of subsequent downlink transmissions the second node 112 may be able to handle, d) the fourth indicator of the number of subsequent downlink transmissions the wireless device 130 may be able to handle, e) the fifth indicator of a Uu metric, and f) the sixth indicator, e.g., the flag, explicitly indicating whether or not the wireless device 130 may have to be changed from the inactive state to the another state.

### Action 702

In this Action 702, the second node 112 receives the further indication.

The receiving in this Action 702 may be from the first node 111.

The receiving in this Action 702 may be performed, e.g., via the second link 142.

The receiving in this Action 702 may be while the wireless device 130 is in inactive state.

The receiving in this Action 702 may be based on the sent first indication.

The further indication is of whether or not the wireless device 130 is to be changed from the inactive state to the another state. In particular examples, the further indication may be of whether or not the wireless device 130 may have to be changed from the inactive state to the another state, to receive the downlink data from the radio network node 110.

In some embodiments, the further indication may be further based on the second indication received by the first node 111 from the third node 113 comprised in the radio network node 110. The third node 113 may be the central node managing the user plane of the radio network node 110. The second indication may indicate whether or not the size of the downlink buffer for data received at the third node 113 to be delivered to the wireless device 130 may exceed or not the one or more thresholds.

### Action 703

In some embodiments, the method may optionally further comprise the following action.

In this Action 703, the second node 112 may initiate changing the state of the wireless device 130 from the inactive state to the another state.

Initiating may be understood as triggering, starting, enabling facilitating or similar.

The initiating changing in this Action 703 may be based on the received further indication.

In any of the above embodiments, at least one of the following may apply: a) the another state may be the state wherein the wireless device 130 may be connected to the radio network node 110, e.g., RRC Connected state, b) the further indication may indicate that the Small Data Transmission procedure is to be stopped, b) the data may be a Small Data Transmission (SDT), c) the communications network 100 may be a Fifth Generation (5G) network, d) the radio network node 110 may be a gNB, e) the first node 111 may be a Central Unit Control Plane (CU-CP), f) the third node 113 may be a CU User Plane (CU-UP), and g) the second node 112 may be a Distributed Unit (DU).

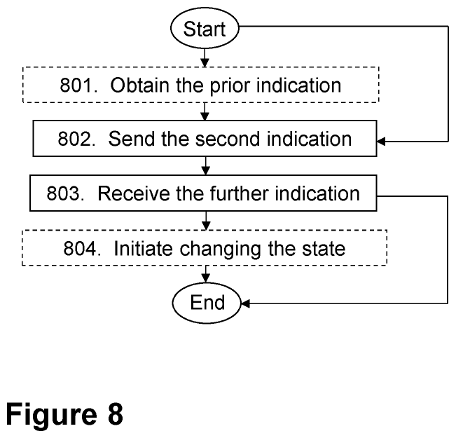

Embodiments of a method performed by a third node, such as the third node 113, will now be described with reference to the flowchart depicted in FIG. 8. The third node 113 is comprised in the radio network node 110. The method is for handling the state of the wireless device 130. The third node 113, the radio network node 110 and the wireless device 130 are operating in a communications network, such as the communications network 100.

The method may be understood to be computer-implemented.

The method may comprise the following actions. Several embodiments are comprised herein. In a particular embodiments, Action 802 and Action 803 may be performed. The method may comprise more of the following actions. In some embodiments, all the actions may be performed. One or more embodiments may be combined, where applicable. It should be noted that the examples herein are not mutually exclusive. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third node 113 is depicted in FIG. 8. In FIG. 8, optional actions in some embodiments may be represented with dashed lines. In some embodiments, the actions may be performed in a different order than that depicted FIG. 8.

The detailed description of some of the following corresponds to the same references provided above, in relation to the actions described for the first node 111 and will thus not be repeated here to simplify the description. For example, the connected mode may be an RRC connected mode.

### Action 801

In some embodiments, in this Action 801, the third node 113 may obtain the prior indication.

Obtaining may comprise fetching or retrieving from a memory, or receiving.

The obtaining in this Action 801 may be from the first node 111.

The obtaining in this Action 801 may be performed by receiving, e.g., via the first link 141.

The prior indication may indicate the one or more thresholds.

Whenever the size of the downlink buffer for data received by the third node 113 for delivery to the wireless device 130 may be equal to or exceed at least one of the one or more thresholds, the third node 113 may have to notify the first node 111.

In particular examples of this Action 801, the third node 113, that is, the gNB-CU-UP, may receive an E1 message indicating the value of the DL data buffer threshold from the first node 111.

### Action 802

The third node 113, in this Action 802, sends the second indication.

The sending in this Action 802 is to the first node 111 comprised in the radio network node 110.

The sending in this Action 802 may be performed, e.g., via the first link 141.

The sending in this Action 802 is while the wireless device 130 is in inactive state.

The second indication indicates whether the wireless device 130 is to be changed from the inactive state to the another state to receive downlink data from the radio network node 110. The data may be small data, e.g., an SDT. In other words, the data may be configured for SDT, e.g., MT-SDT.

The first node 111 is the central node managing the control plane of the radio network node 110. The third node 113 is the central node managing the user plane of the radio network node 110. The second indication indicates whether or not the size of the downlink buffer for data received at the third node 113 to be delivered to the wireless device 130 exceeds or not the one or more thresholds.

The second indication may be sent based on the obtained prior indication.

### Action 803

In this Action 803, the third node 113 receives the further indication.

The receiving in this Action 803 is from the first node 111.

The receiving in this Action 803 may be performed, e.g., via the first link 141.

The receiving in this Action 803 is while the wireless device 130 is in inactive state.

The receiving in this Action 803 is based on the sent second indication.

The further indication is of whether or not the wireless device 130 is to be changed from the inactive state to the another state. In particular examples, the further indication may be of whether or not the wireless device 130 may have to be changed from the inactive state to the another state, to receive the downlink data from the radio network node 110.

In some embodiments, the further indication may be further based on the first indication received by the first node 111 from the second node 112 comprised in the radio network node 110. The second node 112 may manage the distributed unit of the radio network node 110. The first indication may indicate the one or more conditions of the radio channel between the second node 112 and the wireless device 130.

In some embodiments, the one or more conditions may be indicated by the first indication by at least one of: a) the first indicator of the quality of the radio channel, e.g., the CQI, b) the second indicator of the strength of the received reference signal, e.g., the RSRP, c) the third indicator of the number of subsequent downlink transmissions the second node 112 may be able to handle, d) the fourth indicator of the number of subsequent downlink transmissions the wireless device 130 may be able to handle, e) the fifth indicator of a Uu metric, and f) the sixth indicator, e.g., the flag, explicitly indicating whether or not the wireless device 130 is to be changed from the inactive state to the another state.

### Action 804

In some embodiments, the method may optionally further comprise that, in this Action 804, the third node 113 may initiate changing the state of the wireless device 130 from the inactive state to the another state.

The initiating changing in this Action 803 may be based on the received further indication.

Initiating may be understood as triggering, starting, enabling facilitating or similar.

In some embodiments, at least one of the following may apply: a) the one or more thresholds indicated in the prior indication may be based on the one or more conditions of the radio channel indicated by the second node 112 in the first indication, b) the obtaining in Action 801 of the prior indication may be by receiving the prior indication from the first node 111, c) the obtaining in Action 801 of the prior indication may be performed during the E1 message, d) the prior indication may be comprised in one of: the BEARER CONTEXT SETUP REQUEST, the BEARER CONTEXT MODIFICATION REQUEST, and e) the second node 112 may be a Distributed Unit (DU).

In some embodiments, at least one of the following may apply: a) the one or more thresholds may be to be used in combination with the value indicating the time period during which the data may be to be received in the downlink buffer, and b) the second indication may be comprised in the Downlink Data Notification.

In any of the above embodiments, at least one of the following may apply: a) the another state may be the state wherein the wireless device 130 may be connected to the radio network node 110, e.g., RRC Connected state, b) the further indication may be comprised in a BEARER CONTEXT MODIFICATION REQUEST, c) the further indication may indicate that the Small Data Transmission procedure is to be stopped, d) the data may be an SDT, e) the communications network 100 may be a 5G network, f) the radio network node 110 may be a gNB, g) the first node 111 may be a CU-CP, and h) the third node 113 may be a CU-UP.

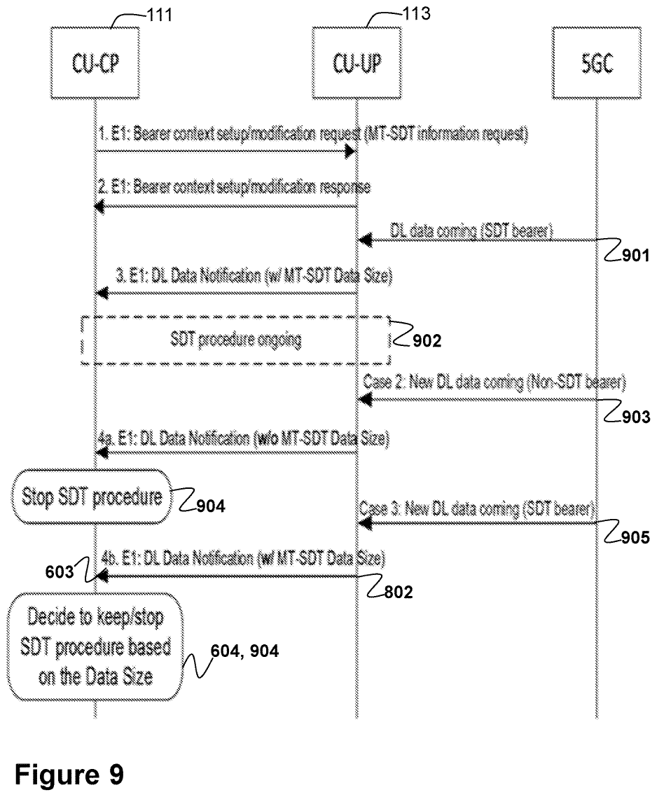

FIG. 9 is a signalling diagram depicting a non-limiting example of cases of subsequent data transmission. At 1, during the setup or modification of the bearer context, the first node 111, a gNB-CU-CP in this example, may request the third node 113, a gNB-CU-UP in this example, to provide MT-SDT information by sending an E1 bearer context setup and modification request comprising an MT-SDT information request. At 2, the third node 113 may send an E1 bearer context setup and modification response to the first node 111. At 901, the third node 113 may receive DL data for a UE in RRC Inactive on NG-U interface from the 5GC. The DL data arrives via an SDT bearer, so the third node 113 may, at 3, signal the MT-SDT data size information over an E1 DL DATA NOTIFICATION message to the first node 111. At 902, the SDT procedure may be ongoing. After triggering of MT-SDT from the network side, the third node 113 may need to keep detecting whether or not there may be any subsequent SDT data arrival during the ongoing MT-SDT session. At 903, according to Case 2 discussed earlier, new non-SDT DL data may arrive to the third node 113 from the 5GC during the ongoing SDT session. In such a case, at 4a, the third node 113 may send a new E1 DL DATA NOTIFICATION message to the first node 111 without the new MT-SDT Information data size IE. This may trigger the first node 111 to stop the SDT procedure at 904. At 905, according to Case 3 discussed earlier, new DL data may arrive at the third node 113 from the 5GC on an SDT bearer which may have become large enough. In such a case, the third node 113 may, at 4b, send an additional E1 DL DATA NOTIFICATION message to the first node 111 with a new indication in the MT-SDT Information IE to indicate to the first node 111 the size of the DL SDT Data. At 906, the CU-CP may then decide whether to keep and/or to stop the SDT procedure based on the data size.

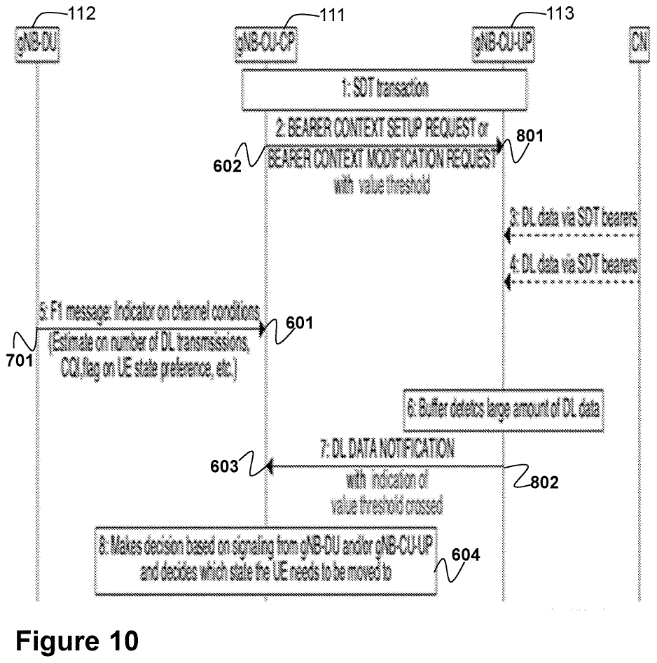

FIG. 10 is a signalling diagram depicting a non-limiting example of DU, CU-CP and CU-UP interaction, according to embodiments herein. In FIG. 10, the first node 111 is a gNB-CU-CP, the second node 112 is a gNB-DU and the third node 113 is a gNB-CU-UP. After a first SDT transaction at 1, at 2, the first node 111 may send, according to Action 602 and Action 801, a BEARER CONTEXT SETUP REQUEST or BEARER CONTEXT MODIFICATION REQUEST to the third node 113 with the second indication comprising a threshold value of the DL data buffer above which the first node 111 may request the third node 113 to be informed when such threshold may be reached during subsequent MT-SDT transmission. At 3 and at 4, the third node 113 may receive new DL data from the CN via SDT bearers. At 5, the second node 112 may inform the first node 111 of channel conditions by sending the first indication in agreement with Action 701 and Action 601, indicating the possibility to keep the UE in RRC_INACTIVE state for DL SDT transactions, during initial and/or subsequent SDT transactions. The first indication, as depicted in FIG. 10, may be an F1 message indicating the channel conditions, e.g., via the first indicator of the CQI and/or the second indicator, the third indication or the fourth indicator with the estimate of the number of subsequent downlink transmissions the second node 112, and/or the UE, respectively, may be able to handle, the sixth indicator with the flag on UE state preference, etc. At 6, the buffer if the third node 113 may detect a large amount of DL data. At 7, the third node 113, in accordance with Action 802 and Action 603, may send the second indication to the first node 111 as a DL DATA NOTIFICATION message with an indication of the value threshold having been crossed. At 8, in agreement with Action 604, the first node 111 may then make a decision based on the signalling received from the second node 112 and the third node 113, as first indication and second indication, respectively, to decide which state the UE may need to be moved to for the next DL data transmission. In one example, the second node 112 may send the F1 message to the first node 111 after a first SDT transaction, after re-establishing all the SDT bearers, e.g., before Step 2 in FIG. 10. Alternately, the second node 112 may also determine the radio channel conditions based on the CQI received or determined from the UE, using for e.g., preamble, before RRCResumeRequest and send this as the F1 message to the first node 111 before establishing the SDT bearers. This may offer the possibility for the network to switch the UE directly to CONNECTED mode without initiating the SDT procedure under poor radio channel conditions.

Certain embodiments disclosed herein may provide one or more of the following technical advantage(s), which may be summarized as follows.

Embodiments herein may be understood to allow the first node 111, e.g., a gNB-CU-CP, to switch the wireless device 130 to RRC connected state if a large amount of DL data appears at the buffer of the third node 113, e.g., a gNB-CU-UP, during subsequent SDT, after the SDT procedure may have been initiated in NG-RAN. This may help to know that SDT transaction may have to be aborted.

Embodiments herein, may also allow the first node 111 to know if, instead, it may keep the wireless device 130 in RRC_INACTIVE state for next subsequent DL SDT transaction based on feedback from second node 112 on Radio channel conditions. This may be even if a large amount of data is received. This may help to improve the overall energy consumption of the wireless device 130.

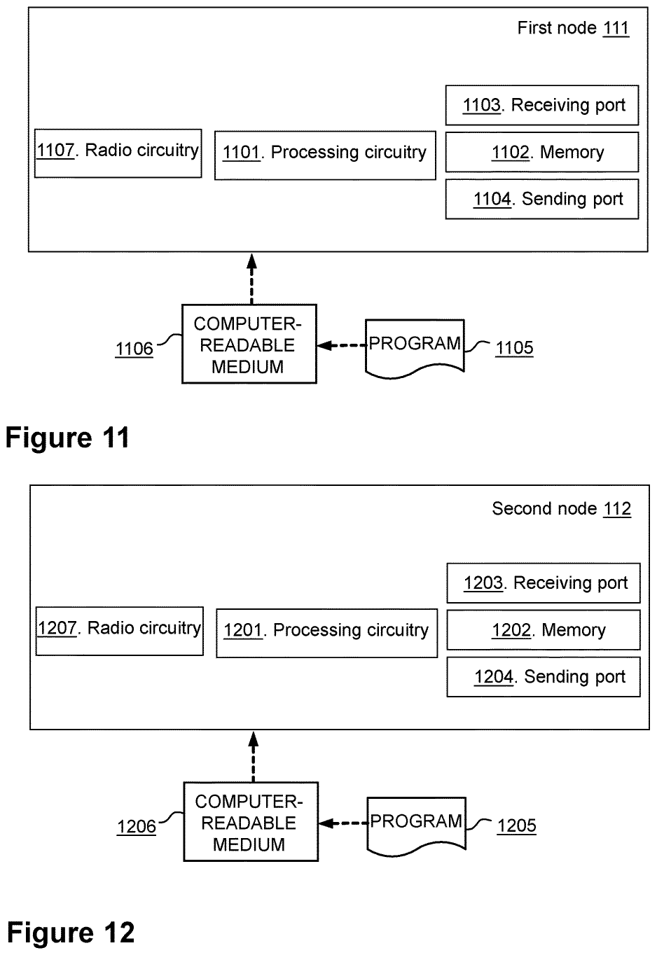

FIG. 11 depicts an example of the arrangement that the first node 111 may comprise to perform the method actions described above in relation to FIG. 6, FIG. 9 and/or FIG. 10. The first node 111 is configured to be comprised in the radio network node 110. The first node 111 is configured for handling the state of the wireless device 130. The first node 111, the radio network node 110 and the wireless device 130 are configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, the connected mode may be an RRC connected mode.

The first node 111 is configured and/or operable to perform the obtaining in Action 601, 603, e.g. by means of a processing circuitry 1101 within the first node 111 configured to, obtain, while the wireless device 130 is in inactive state, the at least one indication from the another node 112, 113 configured to be comprised in the radio network node 110. The at least one indication is configured to indicate whether the wireless device 130 is to be changed from the inactive state to another state to receive downlink data from the radio network node 110.

The first node 111 is configured to be the central node configured to manage the control plane of the radio network node 110, and the at least one indication is configured to be at least one of: a) the first indication, wherein the another node 112 may be configured to be the second node 112 configured to manage the distributed unit of the radio network node 110, and the first indication may be configured to indicate the one or more conditions of the radio channel between the second node 112 and the wireless device 130, and b) the second indication, wherein the another node 113 may be configured to be the third node 113, the third node 113 may be configured to be the central node configured to manage the user plane of the radio network node 110, and the second indication may be configured to indicate whether or not the size of the downlink buffer for data configured to be received at the third node 113 to be delivered to the wireless device 130 exceeds or not the one or more thresholds.

The first node 111 is configured and/or operable to perform the determining in Action 604, e.g. by means of the processing circuitry 1101 within the first node 111 configured to, determine, while the wireless device 130 is in inactive state and based on the at least one indication configured to be obtained, whether the wireless device 130 is to be changed from the inactive state to the another state to receive downlink data from the radio network node 110.

The first node 111 is also configured and/or operable to perform the initiating in Action 605, e.g. by means of the processing circuitry 1101 within the first node 111 configured to, initiate providing the further indication of whether or not the wireless device 130 is to be changed from the inactive state to the another state, based on the result of the determining.

In some embodiments, the one or more conditions may be configured to be indicated by the first indication by at least one of: a) the first indicator of the quality of the radio channel, b) the second indicator of the strength of the received reference signal, c) the third indicator of the number of subsequent downlink transmissions the second node 112 may be able to handle, d) the fourth indicator of the number of subsequent downlink transmissions the wireless device 130 may be able to handle, e) the fifth indicator of the Uu metric, and f) the sixth indicator configured to explicitly indicate whether or not the wireless device 130 may have to be changed from the inactive state to the another state.

In some embodiments, the first node 111 may be further configured with the two following configurations.

In some embodiments, the first node 111 may be configured and/or operable to perform the sending in Action 602, e.g. by means of the processing circuitry 1101 within the first node 111 configured to, send the prior indication to the third node 113. The prior indication may be configured to indicate the one or more thresholds. Whenever the size of the downlink buffer for data configured to be received by the third node 113 for delivery to the wireless device 130 may be equal to or exceed at least one of the one or more thresholds, the third node 113 may be configured to notify the first node 111. The second indication may be configured to be received based on the prior indication configured to be sent.

In some embodiments, the first node 111 may be configured and/or operable to perform the initiating in Action 606, e.g. by means of the processing circuitry 1101 within the first node 111 configured to, initiate changing the state of the wireless device 130 from the inactive state to the another state, based on the result of the determining.

In some embodiments, at least one of the following may apply: a) the one or more thresholds configured to be indicated in the prior indication may be configured to be based on the one or more conditions of the radio channel configured to be indicated by the second node 112 in the first indication, b) the one or more thresholds may be configured to be to be used in combination with the value indicating the time period during which the data may have to be received in the downlink buffer, c) the second indication may be configured to be comprised in a Downlink Data Notification, and d) the sending of the prior indication may be configured to be performed during an E1 message, and e) the prior indication may be configured to be comprised in one of: a BEARER CONTEXT SETUP REQUEST, and a BEARER CONTEXT MODIFICATION REQUEST.

In some embodiments, at least one of the following may apply: a) the another state may be configured to be the state wherein the wireless device 130 may be connected to the radio network node 110, b) the further indication may be configured to indicate that the Small Data Transmission procedure may have to be stopped, c) the first node 111 may be configured to send the further indication to at least one of the third node 113, the second node 112 and the wireless device 130, d) the further indication may be configured to be comprised in a BEARER CONTEXT MODIFICATION REQUEST, e) the data may be configured to be an SDT, f) the communications network 100 may be configured to be a 5G network, g) the radio network node 110 may be configured to be a gNB, h) the first node 111 may be configured to be a CU-CP, i) the third node 113 may be configured to be a CU-UP, and j) the second node 112 may be configured to be a DU.

The embodiments herein in the first node 111 may be implemented through one or more processors, such as a processing circuitry 1101 in the first node 111 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The processing circuitry 1101 may be configured to, or operable to, perform the method actions according to FIG. 6, FIG. 9 and/or FIG. 10.

The first node 111 may further comprise a memory 1102 comprising one or more memory units. The memory 1102 is arranged to be used to store obtained information, store data, configurations, schedulings, and applications etc. to perform the methods herein when being executed in the first node 111.

In some embodiments, the first node 111 may receive information from, e.g., the second node 112, the third node 113, or another structure in the communications network 100, through a receiving port 1103. In some embodiments, the receiving port 1103 may be, for example, connected to one or more antennas in first node 111. In other embodiments, the first node 111 may receive information from another structure in the communications network 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the first node 111 may be further configured to transmit or send information to e.g., the second node 112, the third node 113, or another structure in the communications network 100, through a sending port 1104, which may be in communication with the processing circuitry 1101, and the memory 1102.

Those skilled in the art will also appreciate that the processing circuitry 1101 described above may comprise a combination of analog and digital modules, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first node 111 may be configured to perform the actions of FIG. 6 with respective units that may be implemented as one or more applications running on one or more processors such as the processing circuitry 1101.

Thus, the methods according to the embodiments described herein for the first node 111 may be respectively implemented by means of a computer program 1105 product, comprising instructions, i.e., software code portions, which, when executed on at least one processing circuitry 1101, cause the at least one processing circuitry 1101 to carry out the actions described herein, as performed by the first node 111. The computer program 1105 product may be stored on a computer-readable storage medium 1106. The computer-readable storage medium 1106, having stored there on the computer program 1105, may comprise instructions which, when executed on at least one processing circuitry 1101, cause the at least one processing circuitry 1101 to carry out the actions described herein, as performed by the first node 111. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The first node 111 may comprise a communication interface configured to facilitate communications between the first node 111 and other nodes or devices, e.g., the second node 112, the third node 113, or another structure in the communications network 100. The interface may, for example, include a transceiver configured to transmit and receive radio signals over an air interface in accordance with a suitable standard.

In other embodiments, the first node 111 may also comprise a radio circuitry 1107, which may comprise e.g., the receiving port 1103 and the sending port 1104. The radio circuitry 1107 may be configured to set up and maintain at least a wireless connection with the second node 112, the third node 113, or another structure in the communications network 100. Circuitry may be understood herein as a hardware component.

Hence, embodiments herein also relate to the first node 111 comprising the processing circuitry 1101 and the memory 1102, said memory 1102 containing instructions executable by said processing circuitry 1101, whereby the first node 111 is operative to perform the actions described herein in relation to the first node 111, e.g., in FIG. 6, FIG. 9 and/or FIG. 10.

FIG. 12 depicts an example of the arrangement that the second node 112 may comprise to perform the method actions described above in relation to FIG. 7 and/or FIG. 10. The second node 112 is configured to be comprised in the radio network node 110. The second node 112 is configured to be for handling the state of the wireless device 130. The second node 112, the radio network node 110 and the wireless device 130 are configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112 and will thus not be repeated here. For example, the connected mode may be an RRC connected mode.

The second node 112 is configured and/or operable to perform the sending in Action 701, e.g., by means of a processing circuitry 1201 within the second node 112 configured to, send, while the wireless device 130 is in inactive state, the first indication to the first node 111 configured to be comprised in the radio network node 110. The first indication is configured to indicate whether the wireless device 130 is to be changed from the inactive state to the another state to receive downlink data from the radio network node 110.

The second node 112 is configured and/or operable to perform the receiving in Action 702, e.g., by means of the processing circuitry 1201 within the second node 112 configured to, receive, from the first node 111, while the wireless device 130 is in inactive state and based on the first indication configured to be sent, the further indication of whether or not the wireless device 130 is to be changed from the inactive state to the another state

The second node 112 may be configured and/or operable to perform the initiating in Action 703, e.g., by means of the processing circuitry 1201 within the second node 112 configured to, initiate changing the state of the wireless device 130 from the inactive state to the another state, based on the further indication configured to be received.

The first node 111 is configured to be the central node configured to manage the control plane of the radio network node 110, and the second node 112 is configured to manage the distributed unit of the radio network node 110. The first indication is configured to indicate the one or more conditions of the radio channel between the second node 112 and the wireless device 130.

In some embodiments, the further indication may be configured to be further based on the second indication configured to be received by the first node 111 from the third node 113 configured to be comprised in the radio network node 110. The third node 113 may be configured to be the central node configured to manage the user plane of the radio network node 110. The second indication may be configured to indicate whether or not the size of the downlink buffer for data configured to be received at the third node 113 to be delivered to the wireless device 130 may exceed or not one or more thresholds.

In some embodiments, the one or more conditions may be configured to be indicated by the first indication by at least one of: a) the first indicator of the quality of the radio channel, b) the second indicator of the strength of the received reference signal, c) the third indicator of the number of subsequent downlink transmissions the second node 112 may be able to handle, d) the fourth indicator of the number of subsequent downlink transmissions the wireless device 130 may be able to handle, e) the fifth indicator of the Uu metric, and f) the sixth indicator configured to explicitly indicate whether or not the wireless device 130 may have to be changed from the inactive state to the another state.

In some embodiments, at least one of the following may apply: a) the another state may be configured to be the state wherein the wireless device 130 may be connected to the radio network node 110, b) the further indication may be configured to indicate that the Small Data Transmission procedure may have to be stopped, c) the data may be configured to be an SDT, d) the communications network 100 may be configured to be a 5G network, e) the radio network node 110 may be configured to be a gNB, f) the first node 111 may be configured to be a CU-CP, g) the third node 113 may be configured to be a CU-UP, and h) the second node 112 may be configured to be a DU.

The embodiments herein in the second node 112 may be implemented through one or more processors, such as a processing circuitry 1201 in the second node 112 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The processing circuitry 1201 may be configured to, or operable to, perform the method actions according to FIG. 7 and/or FIG. 10.

The second node 112 may further comprise a memory 1202 comprising one or more memory units. The memory 1202 is arranged to be used to store obtained information, store data, configurations, schedulings, and applications etc. to perform the methods herein when being executed in the second node 112.

In some embodiments, the second node 112 may receive information from, e.g., the wireless device 130, the first node 111, the third node 113 and/or another structure in the communications network 100, through a receiving port 1203. In some embodiments, the receiving port 1203 may be, for example, connected to one or more antennas in the second node 112. In other embodiments, the second node 112 may receive information from another structure in the communications network 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the second node 112 may be further configured to transmit or send information to e.g., the wireless device 130, the first node 111, the third node 113 and/or another structure in the communications network 100, through a sending port 1204, which may be in communication with the processing circuitry 1201, and the memory 1202.

Those skilled in the art will also appreciate that the processing circuitry 1201 described above may comprise a combination of analog and digital modules, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the second node 112 may be configured to perform the actions of FIG. 7 with respective units that may be implemented as one or more applications running on one or more processors such as the processing circuitry 1201.

Thus, the methods according to the embodiments described herein for the second node 112 may be respectively implemented by means of a computer program 1205 product, comprising instructions, i.e., software code portions, which, when executed on at least one processing circuitry 1201, cause the at least one processing circuitry 1201 to carry out the actions described herein, as performed by the second node 112. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the second node 112. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The second node 112 may comprise a communication interface configured to facilitate communications between the second node 112 and other nodes or devices, e.g., the wireless device 130, the first node 111, the third node 113 and/or another structure in the communications network 100. The interface may, for example, include a transceiver configured to transmit and receive radio signals over an air interface in accordance with a suitable standard.

In other embodiments, the second node 112 may also comprise a radio circuitry 1207, which may comprise e.g., the receiving port 1203 and the sending port 1204. The radio circuitry 1207 may be configured to set up and maintain at least a wireless connection with the wireless device 130, the first node 111, the third node 113 and/or another structure in the communications network 100. Circuitry may be understood herein as a hardware component.

Hence, embodiments herein also relate to the second node 112 comprising the processing circuitry 1201 and the memory 1202, said memory 1202 containing instructions executable by said processing circuitry 1201, whereby the second node 112 is operative to perform the actions described herein in relation to the second node 112, e.g., in FIG. 7 and/or FIG. 10.

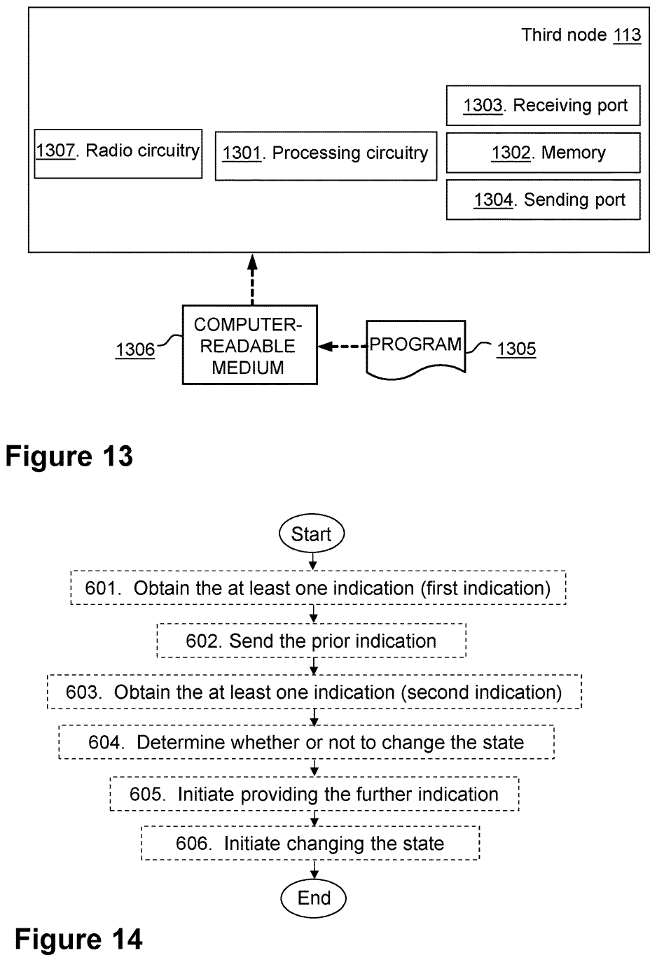

FIG. 13 depicts an example of the arrangement that the third node 113 may comprise to perform the method actions described above in relation to FIG. 8, FIG. 9 and/or FIG. 10. The third node 113 is configured to be comprised in the radio network node 110. The third node 113 is configured to be for handling the state of the wireless device 130. The third node 113, the radio network node 110 and the wireless device 130 are configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third node 113 and will thus not be repeated here. For example, the connected mode may be an RRC connected mode.

The third node 113 is configured and/or operable to perform the sending in Action 802, e.g., by means of a processing circuitry 1301 within the third node 113 configured to, send, while the wireless device 130 is in inactive state, the second indication to the first node 111 configured to be comprised in the radio network node 110. The second indication is configured to indicate whether the wireless device 130 is to be changed from the inactive state to the another state to receive downlink data from the radio network node 110.

The third node 113 is configured and/or operable to perform the receiving in Action 803, e.g., by means of the processing circuitry 1301 within the third node 113 configured to, receive, from the first node 111, while the wireless device 130 is in inactive state and based on the second indication configured to be sent, the further indication of whether or not the wireless device 130 is to be changed from the inactive state to another state.

The first node 111 is configured to be the central node configured to manage the control plane of the radio network node 110, and the third node 113 is configured to be the central node configured to manage the user plane of the radio network node 110. The second indication is configured to indicate whether or not the size of the downlink buffer for data configured to be received at the third node 113 to be delivered to the wireless device 130 exceeds or not the one or more thresholds.

In some embodiments, the further indication may be further configured to be based on the first indication configured to be received by the first node 111 from the second node 112 configured to be comprised in the radio network node 110. The second node 112 may be configured to manage the distributed unit of the radio network node 110, and the first indication may be configured to indicate the one or more conditions of the radio channel between the second node 112 and the wireless device 130.

In some embodiments, the one or more conditions may be configured to be indicated by the first indication by at least one of: a) the first indicator of the quality of the radio channel, b) the second indicator of the strength of the received reference signal, c) the third indicator of the number of subsequent downlink transmissions the second node 112 may be able to handle, d) the fourth indicator of the number of subsequent downlink transmissions the wireless device 130 may be able to handle, e) the fifth indicator of the Uu metric, and f) the sixth indicator configured to explicitly indicate whether or not the wireless device 130 may have to be changed from the inactive state to the another state.

In some embodiments, the third node 113 may be further configured with at least one of the two following configurations.

The third node 113 may be configured and/or operable to perform the obtaining in Action 801, e.g., by means of the processing circuitry 1301 within the third node 113 configured to, obtain the prior indication. The prior indication may be configured to indicate the one or more thresholds. Whenever the size of the downlink buffer for data configured to be received by the third node 113 for delivery to the wireless device 130 may be equal to or exceed at least one of the one or more thresholds, the third node 113 may be configured to notify the first node 111, and the second indication may be configured to be sent based on the prior indication configured to be obtained.

The third node 113 may be configured and/or operable to perform the initiating in Action 804, e.g., by means of the processing circuitry 1301 within the third node 113 configured to, initiate changing the state of the wireless device 130 from the inactive state to the another state, based on the further indication configured to be received.

In some embodiments, at least one of the following may apply: a) the one or more thresholds configured to be indicated in the prior indication may be configured to be based on the one or more conditions of the radio channel configured to be indicated by the second node 112 in the first indication, b) the obtaining of the prior indication may be configured to be by receiving the prior indication from the first node 111, c) the obtaining of the prior indication may be configured to be performed during an E1 message, d) the prior indication may be configured to be comprised in one of: a BEARER CONTEXT SETUP REQUEST, and a BEARER CONTEXT MODIFICATION REQUEST, and e) the second node 112 is configured to be the DU.

In some embodiments, at least one of the following may apply: a) the one or more thresholds may be configured to be used in combination with the value configured to indicate the time period during which the data may have to be received in the downlink buffer, and b) the second indication may be configured to be comprised in a Downlink Data Notification.

In some embodiments, at least one of the following may apply: a) the another state may be configured to be the state wherein the wireless device 130 may be connected to the radio network node 110, b) the further indication may be configured to be comprised in a BEARER CONTEXT MODIFICATION REQUEST, c) the further indication may be configured to indicate that a Small Data Transmission procedure may have to be stopped d) the data may be configured to be an SDT, e) the communications network 100 may be configured to be a 5G network, f) the radio network node 110 may be configured to be a gNB, g) the first node 111 may be configured to be a CU-CP, h) the third node 113 may be configured to be a CU-UP.

The embodiments herein in the third node 113 may be implemented through one or more processors, such as a processing circuitry 1301 in the third node 113 depicted in FIG. 13, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The processing circuitry 1301 may be configured to, or operable to, perform the method actions according to FIG. 8, FIG. 9 and/or FIG. 10.

The third node 113 may further comprise a memory 1302 comprising one or more memory units. The memory 1302 is arranged to be used to store obtained information, store data, configurations, schedulings, and applications etc. to perform the methods herein when being executed in the third node 113.

In some embodiments, the third node 113 may receive information from, e.g., the wireless device 130, the first node 111, the second node 112 and/or another structure in the communications network 100, through a receiving port 1303. In some embodiments, the receiving port 1303 may be, for example, connected to one or more antennas in third node 113. In other embodiments, the third node 113 may receive information from another structure in the communications network 100 through the receiving port 1303. Since the receiving port 1303 may be in communication with the processing circuitry 1301, the receiving port 1303 may then send the received information to the processing circuitry 1301. The receiving port 1303 may also be configured to receive other information.

The processing circuitry 1301 in the third node 113 may be further configured to transmit or send information to e.g., the wireless device 130, the first node 111, the second node 112 and/or another structure in the communications network 100, through a sending port 1304, which may be in communication with the processing circuitry 1301, and the memory 1302.

Those skilled in the art will also appreciate that the processing circuitry 1301 described above may comprise a combination of analog and digital modules, and/or one or more processors configured with software and/or firmware, e.g., stored in memory, that, when executed by the one or more processors such as the processing circuitry 1301, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the third node 113 may be configured to perform the actions of FIG. 8 with respective units that may be implemented as one or more applications running on one or more processors such as the processing circuitry 1301.

Thus, the methods according to the embodiments described herein for the third node 113 may be respectively implemented by means of a computer program 1305 product, comprising instructions, i.e., software code portions, which, when executed on at least one processing circuitry 1301, cause the at least one processing circuitry 1301 to carry out the actions described herein, as performed by the third node 113. The computer program 1305 product may be stored on a computer-readable storage medium 1306. The computer-readable storage medium 1306, having stored thereon the computer program 1305, may comprise instructions which, when executed on at least one processing circuitry 1301, cause the at least one processing circuitry 1301 to carry out the actions described herein, as performed by the third node 113. In some embodiments, the computer-readable storage medium 1306 may be a non-transitory computer-readable storage medium, such as a CD ROM disc, or a memory stick. In other embodiments, the computer program 1305 product may be stored on a carrier containing the computer program 1305 just described, wherein the carrier is one of an electronic signal, optical signal, radio signal, or the computer-readable storage medium 1306, as described above.

The third node 113 may comprise a communication interface configured to facilitate communications between the third node 113 and other nodes or devices, e.g., the wireless device 130, the first node 111, the second node 112 and/or another structure in the communications network 100. The interface may, for example, include a transceiver configured to transmit and receive radio signals over an air interface in accordance with a suitable standard.

In other embodiments, the third node 113 may also comprise a radio circuitry 1307, which may comprise e.g., the receiving port 1303 and the sending port 1304. The radio circuitry 1307 may be configured to set up and maintain at least a wireless connection with the wireless device 130, the first node 111, the second node 112 and/or another structure in the communications network 100. Circuitry may be understood herein as a hardware component.

Hence, embodiments herein also relate to the third node 113 comprising the processing circuitry 1301 and the memory 1302, said memory 1302 containing instructions executable by said processing circuitry 1301, whereby the third node 113 is operative to perform the actions described herein in relation to the third node 113, e.g., in FIG. 8, FIG. 9 and/or FIG. 10.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

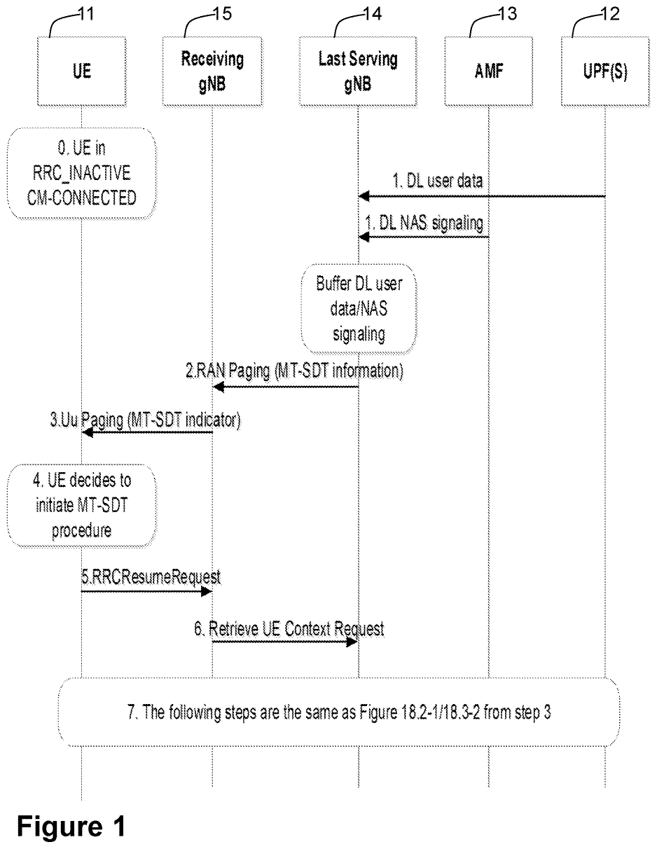

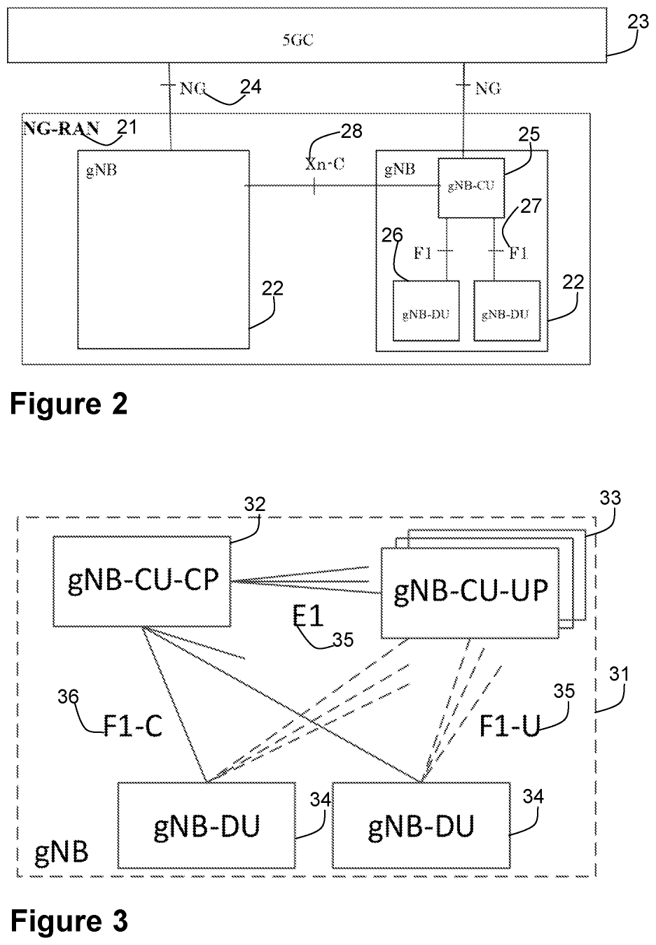

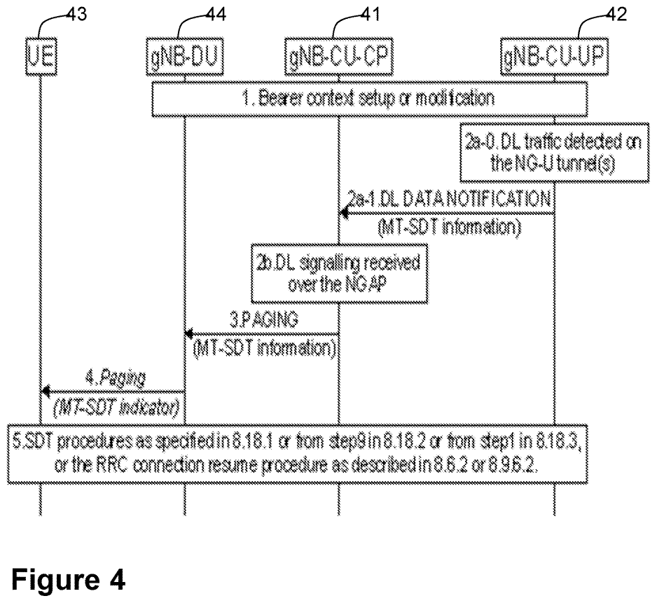

The following are examples related to embodiments herein. Any of the features described in relation to FIGS. 1-13 may be combined with the actions of the examples related to embodiments herein, described in relation to FIGS. 14-16.

The first node 111 embodiments relate to FIG. 14 and FIG. 11.

A method, performed by a first node, such as the first node 111 is described herein. The first node 111 may be comprised in the radio network node 110. The method may be understood to be for handling a state of a wireless device, such as e.g., the wireless device 130. The first node 111, the radio network node 110 and the wireless device 130 may be operating in a communications network, such as the communications network 100.

The method may comprise one or more of the following actions. In particular examples, the method may comprise Action 601 and/or Action 603, Action 604 and Action 605. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 14. In FIG. 14 optional actions in some embodiments may be represented with dashed lines. In some embodiments, the actions may be performed in a different order than that depicted FIG. 14.
Obtaining 601, 603 at least one indication. The first node 111 may be configured and/or operable to perform the obtaining in this Action 601, 603.

The at least one indication may be obtained from another node 112, 113 comprised in the radio network node 110.

Obtaining may comprise receiving, e.g., via the first link 141 from the third node 113 and/or via the second link 142 from the second node 112.

The at least one indication may indicate whether the wireless device 130 is to be changed from the inactive state to another state. In particular examples, the at least one indication may indicate whether the wireless device 130 is to be changed from the inactive state to another state to receive downlink data from the radio network node 110. The data may be small data, e.g., an SDT. In other words, the data may be configured for SDT, e.g., MT-SDT.

The obtaining in this Action 601, 603 may be while the wireless device 130 may be in inactive state.

In some examples, the first node 111 may be a central node managing a control plane of the radio network node 110. In some of such examples, the at least one indication may comprise at least one of:
a first indication; in these examples, the another node 112 may be the second node 112 managing a distributed unit of the radio network node 110; the first indication may indicate one or more conditions of a radio channel between the second node 112, or the radio network node 110, and the wireless device 130, and
a second indication; in these examples, the another node 112 may be the third node 113; the third node 113 may be a central node managing a user plane of the radio network node 110; the second indication may indicate whether or not a size of a downlink buffer for data received at the third node 113 to be delivered to the wireless device 130 exceeds or not one or more thresholds.

In some examples, the at least one indication may be the first indication.

In some examples, the at least one indication may be the second indication.

In some examples, the at least one indication may comprise the first indication and the second indication.

In some embodiments, the one or more conditions may be indicated by the first indication by at least one of:
a first indicator of a quality of the radio channel, e.g., a Channel Quality Indicator (CQI),
a second indicator of a strength of a received reference signal, e.g., a Reference Signal Received Power (RSRP),
a third indicator of a number of subsequent downlink transmissions the second node 112 may be able to handle,
a fourth indicator of a number of subsequent downlink transmissions the wireless device 130 may be able to handle,
a fourth indicator, e.g., a flag, explicitly indicating whether or not the wireless device 130 may have to be changed from the inactive state to the another state, and
a fifth indicator of a Uu metric.
   Determining 604 whether the wireless device 130 may have to be changed from the inactive state to another state. The first node 111 may be configured and/or operable to perform the determining in this Action 604.

Determining may be understood as calculating, selecting or deriving.

The determining in this Action 604 may be whether the wireless device 130 may have to be changed from the inactive state to another state to receive downlink data from the radio network node 110.

The determining in this Action 604 may be while the wireless device 130 may be in inactive state and based on the obtained at least one indication.
Initiating 605 providing a further indication. The first node 111 may be configured and/or operable to perform the initiating in this Action 605.

Initiating providing may be understood as triggering, facilitating, starting or enabling sending, e.g., transmitting, e.g., via the first link 141 and/or the second link 143. The initiating providing in this Action 605 may be to at least one of the second node 112 and the third node 113.

The further indication may be of whether or not the wireless device 130 may have to be changed from the inactive state to another state. In particular examples, the further indication may be of whether or not the wireless device 130 may have to be changed from the inactive state to another state, to receive the downlink data from the radio network node 110.

The initiating providing in this Action 605 may be based on a result of the determining in Action 604.

In some embodiments, the method may further comprise one or more of the following actions:
Sending 602 a prior indication. The first node 111 may be configured and/or operable to perform the sending in this Action 602.

The sending in this Action 602 may be to the third node 113.

The sending in this Action 203 may be, e.g., transmitting, and may be performed, e.g., via the first link 141.

The prior indication may indicate the one or more thresholds.

Whenever the size of the downlink buffer for data received by the third node 113 for delivery to the wireless device 130 may be equal to or exceed at least one of the one or more thresholds, the third node 113 may have to notify the first node 111.

The second indication may be received based on the sent prior indication.
Initiating 606 changing the state of the wireless device 130 from the inactive state to the another state. The first node 111 may be configured and/or operable to perform the initiating in this Action 606.

The initiating changing in this Action 606 may be based on a result of the determining in Action 603.

In some examples, at least one of the following may apply:
the one or more thresholds indicated in the prior indication may be based on the one or more conditions of the radio channel indicated by the second node 112 in the first indication,
the one or more thresholds may be to be used in combination with a value indicating a time period during which the data may be to be received in the downlink buffer,
the second indication may be comprised in a Downlink Data Notification,
the sending in Action 602 of the prior indication may be performed during an E1 message,
the prior indication may be comprised in one of: a BEARER CONTEXT SETUP REQUEST, a BEARER CONTEXT MODIFICATION REQUEST, and
the further indication may be comprised in a BEARER CONTEXT MODIFICATION REQUEST.

In any of the above examples, at least one of the following may apply:
the another state may be a state wherein the wireless device 130 may be connected to the radio network node 110, e.g., RRC Connected state,
the further indication may indicate that a Small Data Transmission procedure is to be stopped,
the first node 111 may send the further indication to at least one of the third node 113, the second node 112 and the wireless device 130,
the data may be a Small Data Transmission, SDT,
the communications network 100 may be a Fifth Generation, 5G, network,
the radio network node 110 may be a gNB,
the first node 111 may be a Central Unit CU Control Plane CP,
the third node 113 may be a CU User Plane UP,
the second node 112 may be a Distributed Unit DU.

In FIG. 14, optional units are indicated with dashed boxes.

The first node 111 may comprise an arrangement as shown in FIG. 11.

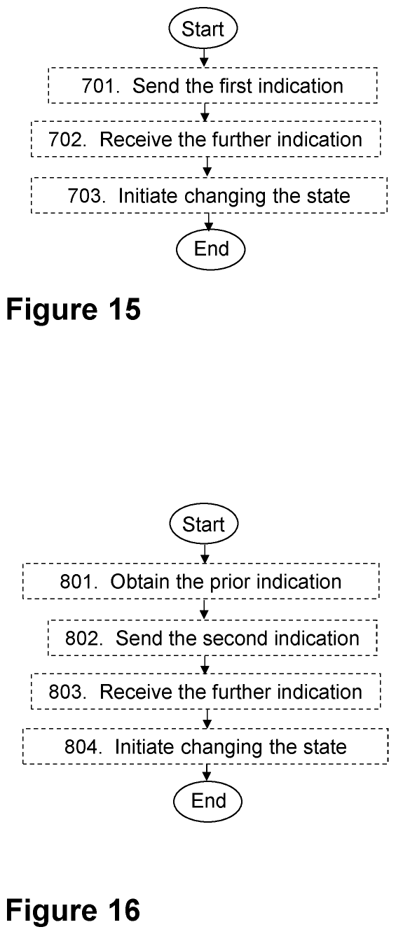

The second node 112 embodiments relate to FIG. 15 and FIG. 12.

A method, performed by a second node, such as the second node 112 is described herein. The method may be understood to be for handling the state of the wireless device 130. The second node 112 may be comprised in the radio network node 110. The second node 112, the radio network node 110 and the wireless device 130 may be operating in a communications network, such as the communications network 100.

The method may comprise one or more of the following actions. In a particular non-limiting example, Action 701, or Action 701 and Action 702 may be performed. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 112 is depicted in FIG. 15. In FIG. 15, optional actions in some embodiments may be represented with dashed lines. In some embodiments, the actions may be performed in a different order than that depicted FIG. 15.

The detailed description of some of the following corresponds to the same references provided above, in relation to the actions described for the first node 111 and will thus not be repeated here to simplify the description. For example, the connected mode may be an RRC connected mode.
Sending 701 the first indication. The second node 112 may be configured and/or operable to perform the sending in this Action 701.

The sending in this Action 701 may be to the first node 111 comprised in the radio network node 110.

The sending in this Action 701 may be performed, e.g., via the second link 142.

The sending in this Action 701 may be while the wireless device 130 may be in inactive state.

The first indication may indicate whether the wireless device 130 may have to be changed from the inactive state to another state to receive downlink data from the radio network node 110. The data may be small data, e.g., an SDT. In other words, the data may be configured for SDT, e.g., MT-SDT.

In some examples, the first node 111 may be the central node managing the control plane of the radio network node 110. The second node 112 may manage a distributed unit of the radio network node 110. In some of such examples, the first indication may indicate the one or more conditions of the radio channel between the second node 112, or the radio network node 110, and the wireless device 130.

In some examples, the further indication may be further based on the second indication received by the first node 111 from the third node 113 comprised in the radio network node 110.

The third node 113 may be the central node managing the user plane of the radio network node 110. The second indication may indicate whether or not the size of the downlink buffer for data received at the third node 113 to be delivered to the wireless device 130 may exceed or not the one or more thresholds.

In some embodiments, the one or more conditions may be indicated by the first indication by at least one of:
the first indicator of a quality of the radio channel, e.g., the Channel Quality Indicator (CQI),
the second indicator of the strength of the received reference signal, e.g., the Reference Signal Received Power (RSRP),
the third indicator of the number of subsequent downlink transmissions the second node 112 may be able to handle,
the fourth indicator of the number of subsequent downlink transmissions the wireless device 130 may be able to handle,
the fourth indicator, e.g., the flag, explicitly indicating whether or not the wireless device 130 may have to be changed from the inactive state to the another state, and
the fifth indicator of a Uu metric.

In some embodiments, the method may further comprise one or more of the following actions:
Receiving 702 the further indication. The second node 112 may be configured and/or operable to perform the receiving in this Action 702.

The receiving in this Action 702 may be from the first node 111.

The receiving in this Action 702 may be performed, e.g., via the second link 142.

The receiving in this Action 702 may be while the wireless device 130 is in inactive state.

The receiving in this Action 702 may be based on the sent first indication.

The further indication may be of whether or not the wireless device 130 may have to be changed from the inactive state to the another state. In particular examples, the further indication may be of whether or not the wireless device 130 may have to be changed from the inactive state to the another state, to receive the downlink data from the radio network node 110.

In some embodiments, the method may optionally further comprise the following action:
Initiating 703 changing the state of the wireless device 130 from the inactive state to the another state. The second node 112 may be configured and/or operable to perform the determining in this Action 703.

Initiating may be understood as triggering, starting, enabling facilitating or similar.

The initiating changing in this Action 703 may be based on the received further indication.

In any of the above examples, at least one of the following may apply:
the another state may be the state wherein the wireless device 130 may be connected to the radio network node 110, e.g., RRC Connected state,
the further indication may indicate that the Small Data Transmission procedure is to be stopped,
the data may be a Small Data Transmission, SDT,
the communications network 100 may be a Fifth Generation, 5G, network,
the radio network node 110 may be a gNB,
the first node 111 may be a Central Unit CU Control Plane CP,
the third node 113 may be a CU User Plane UP, and
the second node 112 may be a Distributed Unit DU.

In FIG. 12, optional units are indicated with dashed boxes.

The second node 112 may comprise an arrangement as shown in FIG. 12.

The third node 113 embodiments relate to FIG. 16 and FIG. 13.

A method, performed by a third node, such as the third node 113 is described herein. The method may be understood to be for handling the state of the wireless device 130. The third node 113 may be comprised in the radio network node 110. The third node 113, the radio network node 110 and the wireless device 130 may be operating in a communications network, such as the communications network 100.

The method may comprise one or more of the following actions. In a particular non-limiting example, Action 801, or Action 801 and Action 802 may be performed. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third node 113 is depicted in FIG. 16. In FIG. 16, optional actions in some embodiments may be represented with dashed lines. In some embodiments, the actions may be performed in a different order than that depicted FIG. 16.

The detailed description of some of the following corresponds to the same references provided above, in relation to the actions described for the first node 111 and will thus not be repeated here to simplify the description. For example, the connected mode may be an RRC connected mode.
Sending 802 the second indication. The third node 113 may be configured and/or operable to perform the sending in this Action 802.

The sending in this Action 802 may be to the first node 111 comprised in the radio network node 110.

The sending in this Action 802 may be performed, e.g., via the first link 141.

The sending in this Action 802 may be while the wireless device 130 may be in inactive state.

The second indication may indicate whether the wireless device 130 may have to be changed from the inactive state to the another state to receive downlink data from the radio network node 110. The data may be small data, e.g., an SDT. In other words, the data may be configured for SDT, e.g., MT-SDT.

In some examples, the first node 111 may be the central node managing the control plane of the radio network node 110. The third node 113 may be the central node managing the user plane of the radio network node 110. The second indication may indicate whether or not the size of the downlink buffer for data received at the third node 113 to be delivered to the wireless device 130 may exceed or not one or more thresholds.

In some embodiments, the method may further comprise one or more of the following actions:
Receiving 803 the further indication. The third node 113 may be configured and/or operable to perform the receiving in this Action 803.

The receiving in this Action 803 may be from the first node 111.

The receiving in this Action 803 may be performed, e.g., via the first link 141.

The receiving in this Action 803 may be while the wireless device 130 may be in inactive state.

The receiving in this Action 803 may be based on the sent second indication.

The further indication may be of whether or not the wireless device 130 may have to be changed from the inactive state to the another state. In particular examples, the further indication may be of whether or not the wireless device 130 may have to be changed from the inactive state to the another state, to receive the downlink data from the radio network node 110.

In some examples, the further indication may be further based on the first indication received by the first node 111 from the second node 112 comprised in the radio network node 110. The second node 112 may be the central node managing the user plane of the radio network node 110. The second indication may manage the distributed unit of the radio network node 110. The first indication may indicate the one or more conditions of the radio channel between the second node 112 and the wireless device 130.

In some embodiments, the one or more conditions may be indicated by the first indication by at least one of:
the first indicator of the quality of the radio channel, e.g., the Channel Quality Indicator (CQI),
the second indicator of the strength of the received reference signal, e.g., the Reference Signal Received Power (RSRP),
the third indicator of the number of subsequent downlink transmissions the second node 112 may be able to handle,
the fourth indicator of the number of subsequent downlink transmissions the wireless device 130 may be able to handle,
the fourth indicator, e.g., the flag, explicitly indicating whether or not the wireless device 130 may have to be changed from the inactive state to the another state, and
the fifth indicator of a Uu metric.

In some embodiments, the method may optionally further comprise one or more of the following actions:
Obtaining 801 the prior indication. The third node 113 may be configured and/or operable to perform the obtaining in this Action 801.

Obtaining may comprise fetching or retrieving from a memory, or receiving.

The obtaining in this Action 801 may be from the first node 111.

The obtaining in this Action 801 may be performed by receiving, e.g., via the first link 141.

The prior indication may indicate the one or more thresholds.

Whenever the size of the downlink buffer for data received by the third node 113 for delivery to the wireless device 130 may be equal to or exceed at least one of the one or more thresholds, the third node 113 may have to notify the first node 111.

The second indication may be sent based on the obtained prior indication.
Initiating 804 changing the state of the wireless device 130 from the inactive state to the another state. The third node 113 may be configured and/or operable to perform the initiating in this Action 804.

Initiating may be understood as triggering, starting, enabling facilitating or similar.

The initiating changing in this Action 803 may be based on the received further indication.

In some examples, at least one of the following may apply:
the one or more thresholds indicated in the prior indication may be based on the one or more conditions of the radio channel indicated by the second node 112 in the first indication,
the obtaining in Action 801 of the prior indication may be by receiving the prior indication from the first node 111,
the obtaining in Action 801 of the prior indication may be performed during the E1 message,
the prior indication may be comprised in one of: the BEARER CONTEXT SETUP REQUEST, the BEARER CONTEXT MODIFICATION REQUEST,
the further indication may be comprised in a BEARER CONTEXT MODIFICATION REQUEST, and
the second node 112 may be a Distributed Unit DU.

In some examples, at least one of the following may apply:
the one or more thresholds may be to be used in combination with the value indicating the time period during which the data may be to be received in the downlink buffer, and
the second indication may be comprised in the Downlink Data Notification.

In any of the above examples, at least one of the following may apply:
the another state may be the state wherein the wireless device 130 may be connected to the radio network node 110, e.g., RRC Connected state,
the further indication may indicate that the Small Data Transmission procedure is to be stopped,
the data may be a Small Data Transmission, SDT,
the communications network 100 may be a Fifth Generation, 5G, network,
the radio network node 110 may be a gNB,
the first node 111 may be a Central Unit CU Control Plane CP,
the third node 113 may be a CU User Plane UP, and
the second node 112 may be a Distributed Unit DU.

In FIG. 13, optional units are indicated with dashed boxes.

The third node 113 may comprise an arrangement as shown in FIG. 13.

Selected examples related to examples herein

EXAMPLE 1. A method performed by a first node (111) comprised in a radio network node (110), the method being for handling a state of a wireless device (130), the first node (111), the radio network node (110) and the wireless device (130) operating in a communications network (100), and the method comprising:
obtaining (601, 603), while the wireless device (130) is in inactive state, at least one indication from another node (112, 113) comprised in the radio network node (110), the at least one indication indicating whether the wireless device (130) is to be changed from the inactive state to another state to receive downlink data from the radio network node (110), and
determining (604), while the wireless device (130) is in inactive state and based on the obtained at least one indication, whether the wireless device (130) is to be changed from the inactive state to another state to receive downlink data from the radio network node (110), and
initiating (605) providing a further indication of whether or not the wireless device (130) is to be changed from the inactive state to another state, based on a result of the determining (604).

EXAMPLE 2. The method according to example 1, wherein the first node (111) is a central node managing a control plane of the radio network node (110), and wherein the at least one indication comprises at least one of:
a first indication, wherein the another node (112) is a second node (112) managing a distributed unit of the radio network node (110), and wherein the first indication indicates one or more conditions of a radio channel between the second node (112) and the wireless device (130), and
a second indication, wherein the another node (112) is a third node (113), the third node (113) being a central node managing a user plane of the radio network node (110), and wherein the second indication indicates whether or not a size of a downlink buffer for data received at the third node (113) to be delivered to the wireless device (130) exceeds or not one or more thresholds.

EXAMPLE 3. The method according to example 2, wherein the one or more conditions are indicated by the first indication by at least one of:
a first indicator of a quality of the radio channel, e.g., a Channel Quality Indicator, CQI,
a second indicator of a strength of a received reference signal, e.g., a Reference Signal Received Power, RSRP,
a third indicator of a number of subsequent downlink transmissions the second node (112) is able to handle,
a fourth indicator of a number of subsequent downlink transmissions the wireless device (130) is able to handle,
a fourth indicator, e.g., a flag, explicitly indicating whether or not the wireless device (130) is to be changed from the inactive state to the another state, and
a fifth indicator of a Uu metric.

EXAMPLE 4. The method according to any of examples 2-3, further comprising:
sending (602) a prior indication to the third node (113), the prior indication indicating the one or more thresholds, wherein whenever the size of the downlink buffer for data received by the third node (113) for delivery to the wireless device (130) is equal to or exceeds at least one of the one or more thresholds, the third node (113) is to notify the first node (111), and wherein the second indication is received based on the sent prior indication, and
initiating (606) changing the state of the wireless device (130) from the inactive state to the another state, based on a result of the determining (603).

EXAMPLE 5. The method according to example 4, wherein at least one of:
the one or more thresholds indicated in the prior indication are based on the one or more conditions of the radio channel indicated by the second node (112) in the first indication,
the one or more thresholds are to be used in combination with a value indicating a time period during which the data is to be received in the downlink buffer,
the second indication is comprised in a Downlink Data Notification, and
the sending (602) of the prior indication is performed during an E1 message, and
the prior indication is comprised in one of: a BEARER CONTEXT SETUP REQUEST, a BEARER CONTEXT MODIFICATION REQUEST.

EXAMPLE 6. The method according to any of examples 1-5, wherein at least one of:
the another state is a state wherein the wireless device (130) is connected to the radio network node (110),
the further indication indicates that a Small Data Transmission procedure is to be stopped,
the first node (111) sends the further indication to at least one of the third node (113), the second node (112) and the wireless device (130),
the further indication is comprised in a BEARER CONTEXT MODIFICATION REQUEST,
the data is a Small Data Transmission, SDT,
the communications network (100) is a Fifth Generation, 5G, network,
the radio network node (110) is a gNB,
the first node (111) is a Central Unit (CU) Control Plane (CP),
the third node (113) is a CU User Plane (UP),
the second node (112) is a Distributed Unit (DU).

EXAMPLE 7. A method performed by a second node (112) comprised in a radio network node (110), the method being for handling a state of a wireless device (130), the second node (112), the radio network node (110) and the wireless device (130) operating in a communications network (100), and the method comprising:
sending (701), while the wireless device (130) is in inactive state, a first indication to a first node (111) comprised in the radio network node (110), the first indication indicating whether the wireless device (130) is to be changed from the inactive state to another state to receive downlink data from the radio network node (110), and
receiving (702), from the first node (111), while the wireless device (130) is in inactive state and based on the sent first indication, a further indication of whether or not the wireless device (130) is to be changed from the inactive state to another state.

EXAMPLE 8. The method according to example 7, wherein the first node (111) is a central node managing a control plane of the radio network node (110), and wherein the second node (112) manages a distributed unit of the radio network node (110), and wherein the first indication indicates one or more conditions of a radio channel between the second node (112) and the wireless device (130).

EXAMPLE 9. The method according to any of examples 7-8, wherein the further indication is further based on a second indication received by the first node (111) from a third node (113) comprised in the radio network node (110), the third node (113) being a central node managing a user plane of the radio network node (110), and wherein the second indication indicates whether or not a size of a downlink buffer for data received at the third node (113) to be delivered to the wireless device (130) exceeds or not one or more thresholds.

EXAMPLE 10. The method according to example 8, wherein the one or more conditions are indicated by the first indication by at least one of:
a first indicator of a quality of the radio channel, e.g., a Channel Quality Indicator, CQI,
a second indicator of a strength of a received reference signal, e.g., a Reference Signal Received Power, RSRP,
a third indicator of a number of subsequent downlink transmissions the second node (112) is able to handle,
a fourth indicator of a number of subsequent downlink transmissions the wireless device (130) is able to handle,
a fourth indicator, e.g., a flag, explicitly indicating whether or not the wireless device (130) is to be changed from the inactive state to the another state, and
a fifth indicator of a Uu metric.

EXAMPLE 11. The method according to any of examples 8-10, further comprising:
initiating (703) changing the state of the wireless device (130) from the inactive state to the another state, based on the received further indication.

EXAMPLE 12. The method according to any of examples 7-11, wherein at least one of:
the another state is a state wherein the wireless device (130) is connected to the radio network node (110),
the further indication indicates that a Small Data Transmission procedure is to be stopped,
the data is a Small Data Transmission, SDT,
the communications network (100) is a Fifth Generation, 5G, network,
the radio network node (110) is a gNB,
the first node (111) is a Central Unit (CU) Control Plane (CP), and
the second node (112) is a Distributed Unit (DU).

EXAMPLE 13. A method performed by a third node (113) comprised in a radio network node (110), the method being for handling a state of a wireless device (130), the third node (113), the radio network node (110) and the wireless device (130) operating in a communications network (100), and the method comprising:
sending (802), while the wireless device (130) is in inactive state, a second indication to a first node (111) comprised in the radio network node (110), the second indication indicating whether the wireless device (130) is to be changed from the inactive state to another state to receive downlink data from the radio network node (110), and
receiving (803), from the first node (111), while the wireless device (130) is in inactive state and based on the sent second indication, a further indication of whether or not the wireless device (130) is to be changed from the inactive state to another state.

EXAMPLE 14. The method according to example 13, wherein the first node (111) is a central node managing a control plane of the radio network node (110), and the third node (113) is a central node managing a user plane of the radio network node (110), and wherein the second indication indicates whether or not a size of a downlink buffer for data received at the third node (113) to be delivered to the wireless device (130) exceeds or not one or more thresholds.

EXAMPLE 15. The method according to example 14, wherein the further indication is further based on a first indication received by the first node (111) from a second node (112) comprised in the radio network node (110), the second node (112) managing a distributed unit of the radio network node (110), and wherein the first indication indicates one or more conditions of a radio channel between the second node (112) and the wireless device (130).

EXAMPLE 16. The method according to example 15, wherein the one or more conditions are indicated by the first indication by at least one of:
a first indicator of a quality of the radio channel, e.g., a Channel Quality Indicator, CQI,
a second indicator of a strength of a received reference signal, e.g., a Reference Signal Received Power, RSRP,
a third indicator of a number of subsequent downlink transmissions the second node (112) is able to handle,
a fourth indicator of a number of subsequent downlink transmissions the wireless device (130) is able to handle,
a fourth indicator, e.g., a flag, explicitly indicating whether or not the wireless device (130) is to be changed from the inactive state to the another state, and
a fifth indicator of a Uu metric.

EXAMPLE 17. The method according to cany of examples 14-16, further comprising at least one of:
obtaining (801) a prior indication, the prior indication indicating the one or more thresholds, wherein whenever the size of the downlink buffer for data received by the third node (113) for delivery to the wireless device (130) is equal to or exceeds at least one of the one or more thresholds, the third node (113) is to notify the first node (111), and wherein the second indication is sent based on the obtained prior indication, and
initiating (804) changing the state of the wireless device (130) from the inactive state to the another state, based on the received further indication.

EXAMPLE 18. The method according to example 17 and any of examples 15-16, wherein at least one of:
the one or more thresholds indicated in the prior indication are based on the one or more conditions of the radio channel indicated by the second node (112) in the first indication,
the obtaining (801) of the prior indication is by receiving the prior indication from the first node (111),
the obtaining (801) of the prior indication is performed during an E1 message,
the prior indication is comprised in one of: a BEARER CONTEXT SETUP REQUEST, a BEARER CONTEXT MODIFICATION REQUEST, and
the second node (112) is a Distributed Unit (DU).

EXAMPLE 19. The method according to any of examples 14-18, wherein at least one of:
the one or more thresholds are to be used in combination with a value indicating a time period during which the data is to be received in the downlink buffer, and
the second indication is comprised in a Downlink Data Notification.

EXAMPLE 20. The method according to any of examples 13-19, wherein at least one of:
the another state is a state wherein the wireless device (130) is connected to the radio network node (110),
the further indication is comprised in a BEARER CONTEXT MODIFICATION REQUEST,
the further indication indicates that a Small Data Transmission procedure is to be stopped,
the data is a Small Data Transmission, SDT,
the communications network (100) is a Fifth Generation, 5G, network,
the radio network node (110) is a gNB,
the first node (111) is a Central Unit (CU) Control Plane (CP), and
the third node (113) is a CU User Plane (UP).

The first node 111 embodiments relate to FIG. 6, FIG. 9 and FIG. 10, FIG. 11.

The first node 111 may comprise an arrangement as shown in FIG. 11.

The second node 112 embodiments relate to FIG. 7, FIG. 10 and FIG. 12.

The second node 112 may comprise an arrangement as shown in FIG. 12.

The third node 113 embodiments relate to FIG. 8, FIG. 10 and FIG. 13.

The third node 113 may comprise an arrangement as shown in FIG. 13.

### REFERENCES

1. 3GPP TS 37.483 v. 17.4.0 https://www.3gpp.org/ftp/Specs/archive/37_series/37.483/37483-h40.zip
2. 3GPP TS 38.401 v17.4.0 https://www.3gpp.org/ftp/Specs/archive/38 series/38.401/38401-h40.zip
3. 3GPP TS 38.473 v17.4.1 https://www.3gpp.org/ftp/Specs/archive/38_series/38.473/3 8473-h41.zip

1-34. (canceled)

35. A method performed by a first node comprised in a radio network node, for handling a state of a wireless device, the first node, the radio network node and the wireless device operating in a communications network, and the method comprising:
obtaining, while the wireless device is in an inactive state, at least one indication from another node comprised in the radio network node, the at least one indication indicating whether the wireless device is to be changed from the inactive state to another state to receive downlink data from the radio network node;
determining, while the wireless device is in the inactive state and based on the obtained at least one indication, whether the wireless device is to be changed from the inactive state to the other state to receive the downlink data from the radio network node; and
initiating providing a further indication of whether the wireless device is to be changed from the inactive state to the other state, based on a result of the determining;
wherein the first node is a central node managing a control plane of the radio network node, and wherein the at least one indication comprises at least one of a first indication where the other node is a second node managing a distributed unit of the radio network node and the first indication indicates one or more conditions of a radio channel between the second node and the wireless device, and a second indication where the other node is a third node being a central node managing a user plane of the radio network node and the second indication indicates whether a size of a downlink buffer for data received at the third node to be delivered to the wireless device exceeds one or more thresholds.

36. The method according to claim 35, wherein the one or more conditions are indicated by the first indication by at least one of:
a first indicator of a quality of the radio channel,
a second indicator of a strength of a received reference signal,
a third indicator of a number of subsequent downlink transmissions the second node is able to handle,
a fourth indicator of a number of subsequent downlink transmissions the wireless device is able to handle,
a fifth indicator of a Uu metric, and
a sixth indicator explicitly indicating whether the wireless device is to be changed from the inactive state to the other state.

37. The method according to claim 35, further comprising:
sending a prior indication to the third node, the prior indication indicating the one or more thresholds, wherein whenever the size of the downlink buffer for data received by the third node for delivery to the wireless device is equal to or exceeds at least one of the one or more thresholds, the third node is to notify the first node, and wherein the second indication is received based on the sent prior indication, and
initiating changing the state of the wireless device from the inactive state to the other state, based on a result of the determining.

38. The method according to claim 37, wherein at least one of:
the one or more thresholds indicated in the prior indication are based on the one or more conditions of the radio channel indicated by the second node in the first indication,
the one or more thresholds are to be used in combination with a value indicating a time period during which the data is to be received in the downlink buffer,
the second indication is comprised in a Downlink Data Notification, and
the sending of the prior indication is performed during an E1 message, and
the prior indication is comprised in one of: a BEARER CONTEXT SETUP REQUEST, and a BEARER CONTEXT MODIFICATION REQUEST.

39. The method according to claim 35, wherein at least one of:
the other state is a state wherein the wireless device is connected to the radio network node,
the further indication indicates that a Small Data Transmission procedure is to be stopped,
the first node sends the further indication to at least one of the third node, the second node and the wireless device,
the further indication is comprised in a BEARER CONTEXT MODIFICATION REQUEST,
the data is a Small Data Transmission (SDT),
the communications network is a Fifth Generation (5G) network,
the radio network node is a gNB,
the first node is a Central Unit (CU) Control Plane (CP),
the third node is a CU User Plane (UP),
the second node is a Distributed Unit (DU).

40. A method performed by a second node comprised in a radio network node, for handling a state of a wireless device, the second node, the radio network node and the wireless device operating in a communications network, and the method comprising:
sending, while the wireless device is in inactive state, a first indication to a first node comprised in the radio network node, the first indication indicating whether the wireless device is to be changed from the inactive state to another state to receive downlink data from the radio network node; and
receiving, from the first node, while the wireless device is in the inactive state and based on the sent first indication, a further indication of whether the wireless device is to be changed from the inactive state to the other state;
wherein the first node is a central node managing a control plane of the radio network node, and wherein the second node manages a distributed unit of the radio network node, and wherein the first indication indicates one or more conditions of a radio channel between the second node and the wireless device.

41. The method according to claim 40, wherein the further indication is further based on a second indication received by the first node from a third node comprised in the radio network node, the third node being a central node managing a user plane of the radio network node, and wherein the second indication indicates whether a size of a downlink buffer for data received at the third node to be delivered to the wireless device exceeds one or more thresholds.

42. The method according to claim 41, wherein the one or more conditions are indicated by the first indication by at least one of:
a first indicator of a quality of the radio channel,
a second indicator of a strength of a received reference signal,
a third indicator of a number of subsequent downlink transmissions the second node is able to handle,
a fourth indicator of a number of subsequent downlink transmissions the wireless device is able to handle,
a fifth indicator of a Uu metric, and
a sixth indicator explicitly indicating whether the wireless device is to be changed from the inactive state to the other state.

43. The method according to claim 40, further comprising:
initiating changing the state of the wireless device from the inactive state to the other state, based on the received further indication.

44. The method according to claim 40, wherein at least one of:
the other state is a state wherein the wireless device is connected to the radio network node,
the further indication indicates that a Small Data Transmission procedure is to be stopped,
the data is a Small Data Transmission (SDT),
the communications network is a Fifth Generation (5G) network,
the radio network node is a gNB,
the first node is a Central Unit (CU) Control Plane (CP) and
the second node is a Distributed Unit (DU).

45. A first node configured for operation in a radio network node, the radio network node and a wireless device being configured to operate in a communications network, the first node operative to handle a state of the wireless device based on the first node being configured to:
obtain, while the wireless device is in an inactive state, at least one indication from another node comprised in the radio network node, the at least one indication indicating whether the wireless device is to be changed from the inactive state to another state to receive downlink data from the radio network node;
determine, while the wireless device is in the inactive state and based on the at least one indication, whether the wireless device is to be changed from the inactive state to the other state to receive the downlink data from the radio network node; and
initiate providing a further indication of whether the wireless device is to be changed from the inactive state to the other state, based on a result of the determining;
wherein the first node is a central node configured to manage a control plane of the radio network node, and wherein the at least one indication comprises at least one of: a first indication where the other node is a second node configured to manage a distributed unit of the radio network node and the first indication indicates one or more conditions of a radio channel between the second node and the wireless device, and a second indication where the other node is a third node configured as a central node for managing a user plane of the radio network node and the second indication indicates whether a size of a downlink buffer for data configured to be received at the third node to be delivered to the wireless device exceeds one or more thresholds.

46. The first node according to claim 45, wherein the one or more conditions are configured to be indicated by the first indication by at least one of:
a first indicator of a quality of the radio channel,
a second indicator of a strength of a received reference signal,
a third indicator of a number of subsequent downlink transmissions the second node is able to handle,
a fourth indicator of a number of subsequent downlink transmissions the wireless device is able to handle,
a fifth indicator of a Uu metric, and
a sixth indicator configured to explicitly indicate whether the wireless device is to be changed from the inactive state to the other state.

47. The first node according to claim 45, being further configured to:
send a prior indication to the third node, the prior indication being configured to indicate the one or more thresholds, wherein whenever the size of the downlink buffer for data configured to be received by the third node for delivery to the wireless device is equal to or exceeds at least one of the one or more thresholds, the third node is configured to notify the first node, and wherein the second indication is configured to be received based on the prior indication configured to be sent, and
initiate changing the state of the wireless device from the inactive state to the other state, based on a result of the determining.

48. The first node according to claim 47, wherein at least one of:
the one or more thresholds configured to be indicated in the prior indication are configured to be based on the one or more conditions of the radio channel configured to be indicated by the second node in the first indication,
the one or more thresholds are configured to be to be used in combination with a value indicating a time period during which the data is to be received in the downlink buffer,
the second indication is configured to be comprised in a Downlink Data Notification, and
the sending of the prior indication is configured to be performed during an E1 message, and
the prior indication is configured to be comprised in one of: a BEARER CONTEXT SETUP REQUEST, and a BEARER CONTEXT MODIFICATION REQUEST.

49. The first node according to claim 45, wherein at least one of:
the other state is a state wherein the wireless device is connected to the radio network node,
the further indication indicates that a Small Data Transmission procedure is to be stopped,
the first node is configured to send the further indication to at least one of the third node, the second node and the wireless device,
the further indication is comprised in a BEARER CONTEXT MODIFICATION REQUEST,
the data is a Small Data Transmission (SDT),
the communications network is a Fifth Generation (5G) network,
the radio network node is a gNB,
the first node is a Central Unit (CU) Control Plane (CP),
the third node is a CU User Plane (UP),
the second node is a Distributed Unit (DU).

50. A second node configured for operation in a radio network node, the radio network node and a wireless device being configured to operate in a communications network, and the second node operative to handle a state of the wireless device based on second node being configured to:
send, while the wireless device is in an inactive state, a first indication to a first node included in the radio network node, the first indication indicating whether the wireless device is to be changed from the inactive state to another state to receive downlink data from the radio network node, and
receive, from the first node, while the wireless device is in the inactive state and based on the first indication, a further indication of whether the wireless device is to be changed from the inactive state to the other state, wherein the first node is a central node configured to manage a control plane of the radio network node, and wherein the second node is configured to manage a distributed unit of the radio network node, and wherein the first indication indicates one or more conditions of a radio channel between the second node and the wireless device.

51. The second node according to claim 50, wherein the further indication is based on a second indication received by the first node from a third node included in the radio network node, the third node being a central node configured to manage a user plane of the radio network node, and wherein the second indication indicates whether a size of a downlink buffer for data to be received at the third node for delivery to the wireless device exceeds one or more thresholds.

52. The second node according to claim 51, wherein the one or more conditions are configured to be indicated by the first indication by at least one of:
a first indicator of a quality of the radio channel,
a second indicator of a strength of a received reference signal,
a third indicator of a number of subsequent downlink transmissions the second node is able to handle,
a fourth indicator of a number of subsequent downlink transmissions the wireless device is able to handle,
a fifth indicator of a Uu metric, and
a sixth indicator configured to explicitly indicate whether the wireless device is to be changed from the inactive state to the other state.

53. The second node according to claim 50, wherein the second node is further configured to initiate changing the state of the wireless device from the inactive state to the other state, based on the further indication.

54. The second node according to claim 50, wherein at least one of:
the other state is a state wherein the wireless device is connected to the radio network node,
the further indication indicates that a Small Data Transmission procedure is to be stopped,
the data is a Small Data Transmission (SDT),
the communications network is a Fifth Generation (5G) network,
the radio network node is a gNB,
the first node is a Central Unit (CU) Control Plane (CP), and
the second node is a Distributed Unit (DU).
